(19) United States
(12) Patent Application Publication
(10) Pub. No.: US 2016/0363160 A1
(43) Pub. Date: Dec. 15, 2016

(54) DEVICE CAPABLE OF ADHERING BY SUCTION TO OBJECT SURFACE AND TRAVELING THEREALONG

(71) Applicant: URAKAMI LLC, Yokohama-shi, Kanagawa (JP)

(72) Inventor: Fukashi URAKAMI, Yokohama-shi (JP)

(73) Assignee: URAKAMI LLC, Yokohama-shi,Kanagawa (JP)

(21) Appl. No.: 15/109,037

(22) PCT Filed: Dec. 20, 2014
(86) PCT No.: PCT/JP2014/083809

§ 371 Date: Sep. 1, 2016

(30) Foreign Application Priority Data
Dec. 30, 2013 (JP) 2013-273734
Jan. 3, 2014 (JP) 2014-000005
Jan. 6, 2014 (JP) 2014-000199
Dec. 8, 2014 (JP) 2014-247953

(51) Int. Cl. F16B 47/00; B62D 57/024; B62D 57/032; F16B 1/00; B08B 3/02

(52) U.S. Cl. CPC F16B 47/00; F16B 1/00; B08B 3/024; B62D 57/032; B62D 57/024; F16B 2001/0035

(57) ABSTRACT

To provide a simple, lightweight, and low-cost device that is capable of adhering by suction to an object surface and moving therealong. This device is at least formed from a suctioning unit, horizontally reciprocating units, vertically reciprocating units, and double-acting leg members. As a first step for enabling the device to travel along an object surface, the double-acting leg members are strongly pressed against the object surface. As a second step, the suctioning unit is moved in the traveling direction of the device with the double-acting leg members strongly pressed against the object surface. As a third step, the double-acting leg members are separated from the object surface. As a fourth step, with the double-acting leg members separated from the object surface, the double-acting leg members are moved in the traveling direction of the device and returned to the state immediately prior to the first step. Thereafter, the actions of the first to fourth steps are repeated.

### TECHNICAL FIELD

This invention relates to a “device capable of adhering to an object surface and moving therealong” which can adhere to a surface of an object like a steel structure like a hull, a tank of every kind, a bridge and piping, or a concrete structure like a tank of every kind, a building, a cictern, a bridge and piping, by using an adhering unit like a vacuum sucker or a magnet capable of adhering to the object surface, or which renders an action to the object surface like jetting a surface-treating material or obtaining information from the object surface for inspection thereof, while adhering to the object surface and moving therealong.

### BACKGROUND OF THE INVENTION

A publicly-known technology of this kind has been laid out by the inventor of this invention in “Device Adhering to Wall Surface and Movable therealong” of Japanese Patent Publication No. 2689127, and “Device Adhering to Wall Surface and Movable therealong” of Japanese Patent Publication No. 2805614.

The device mentioned above comprises: a device body; wheels mounted on the device body to serve as a moving means; a negative pressure suction seal connected to the device body with its free end being brought into contact with the object surface, and rotatable around a rotational axis perpendicular to the body surface; a negative pressure generating means for discharging to the outside the fluid inside a decompressed area confined by the device body, the object surface and the negative pressure suction seal; and a vacuum breaking valve for maintaining the negative pressure at an arbitrary value by allowing surrounding fluid to flow into the decompressed area when the negative pressure inside the decompressed area increases to reach or exceed the arbitrary value of pressure, or in other words, a relief valve or so-called a vacuum breaker, in general, for keeping a vacuum pressure constant.

The relief valve is not necessarily attached directly to the device body, but may be attached to a proximity part of a suction hose, connecting the device body to the negative pressure generating means, near the device body.

In the device like this, when the negative pressure generating means is energized, the fluid inside the decompressed area is discharged to the outside. Fluid pressure applied to the device body due to the difference in fluid pressure between the inside and the outside of the decompressed area is transmitted to the object surface by the intermediary of the wheels, and the device is allowed to adhere to the object surface by the fluid pressure. When the wheels are rotationally driven by a driving means like an electric motor in the adhering state like this, the device is moved along the object surface by the action of the wheels.

Further, when the negative pressure suction seal with a polishing member like a polishing cloth mounted thereon is rotated, the object surface is polished and cleaned. In addition, the dust generated during the polishing and cleaning work is suctioned and recovered by the action of the negative pressure generating means.

The device like this can safely and efficiently perform various cleaning works on the object surface by means of remote control without generating dust.

Patent Document 1: Japanese Patent Publication No. 2689127

Patent Document 2: Japanese Patent Publication No. 2805614

### DISCLOSURE OF THE INVENTION

### Problems to be Solved

The above-mentioned “Device Adhering to Wall Surface and Movable therealong” disclosed in the Japanese Patent Publication No. 2689127 and the Japanese Patent Publication No. 2805614 has following problems to be solved.

Namely, the “Device Adhering to Wall Surface and Movable therealong” is easy to travel continuously because a rotational driving means like the electric motor is equipped. On the other hand, in order to achieve intermittent traveling in which the device suspends after traveling a predetermined distance, resumes traveling the predetermined distance after a predetermined suspension time elapses and repeats the actions thereafter, a displacement sensor like a servo motor or a rotary encoder, and an electric control system are needed, which increase the cost of the device.

Further, the wheels provided with a rotary shaft and a bearing, the servo motor with a reduction gear, and a transmission mechanism transmitting the rotational driving force of the motor to the wheels have substantial weight. In the meantime, in the device of this invention, a working device working on the objet surface like jetting a surface treating material, or an inspection device for obtaining information from the object surface for inspection of the object surface needs to reciprocate in the direction intersecting with the traveling direction of the device of the invention and along the object surface to perform scanning of the object surface.

A traveling mode needed for the device of the invention is as follows. Namely, as a first step, outward scanning is performed by the working device or the inspection device, as a second step, the device suspends after traveling a predetermined distance, as a third step, homeward scanning is performed by the working device or the inspection device, as a fourth step, the device suspends after traveling a predetermined distance, and the steps 1 to 4 are repeated thereafter. The intermittent traveling mode as mentioned above is required.

Accordingly, a problem to be solved by this invention is to provide “a device capable of adhering to an object surface and traveling therealong” having a simple structure and reduced weight, incurring lower manufacturing cost, and capable of intermittent traveling with high positional accuracy.

In a “device capable of adhering to an object surface made of a magnetic body like a steel plate by using magnetic force of an adhering unit comprising an electromagnet or a permanent magnet, and capable of traveling therealong”, when a gap between the adhering unit and the object surface is widened due to a problem caused by characteristics of magnetic force, adhering force of the adhering unit to the object surface is reduced sharply.

Accordingly, the problem to be solved by this invention is to provide “a device capable of adhering to the oabject surface and traveling terealong” while maintaining the state that the adhering unit is in tight contact with the object surface, in the “device capable of adhering to an object surface made of a magnetic body like a steel plate by using magnetic force of an adhering unit comprising an electromagnet or a permanent magnet, and capable of traveling therealong”.

Needless to say, it is required to provide the device having a simple structure and reduced weight, incurring lower manufacturing cost, and capable of intermittent traveling with high positional accuracy also in the “device capable of adhering to an object surface made of a magnetic body like a steel plate by using magnetic force of an adhering unit comprising an electromagnet or a permanent magnet, and capable of traveling therealong”.

### Means to Solve the Problem 1

In order to solve the above-mentioned problem, according to the first invention related to this invention, “a device capable of adhering to an object surface and traveling therealong” as described in Claim 2, for example, is provided.

Namely, the device capable of adhering to the object surface and traveling therealong comprises:

an adhering unit adhering to the object surface by the action of negative pressure;

horizontal reciprocation units respectively arranged on right and left sides of the adhering unit with respect to the moving direction thereof, and capable of reciprocating in a front-back direction of the moving direction;

vertical reciprocation units mounted on each of the horizontal reciprocation units and capable of reciprocating in the direction intersecting with the object surface;

double-acting leg members made of a material having a large friction coefficient like a polyurethane, respectively mounted on the vertical reciprocation units, and capable of reciprocating in the direction intersecting with the object surface;

a working device working on the object surface to jet a surface treating material, etc., or an inspection device obtaining information from the object surface to inspect the object surface, etc.; and

a second allowing the working device or the inspection device to reciprocate along the object surface in the direction intersecting with the moving direction of the adhering unit;

in which, in order to enable the working device or the inspection device to perform scanning along the object surface and to enable the device adhering to the object surface to travel along the object surface;

as a first step, the working device or the inspection device performs outward or homeward scanning by the action of the second horizontal reciprocation unit, and at the same time, the double-acting leg members are moved in the traveling direction of the device by driving the horizontal reciprocation units while maintaining the state that the double-acting leg members are separated from the object surface;

as a second step, the double-acting leg members are strongly pressed against the object surface by the action of the vertical reciprocation units;

as a third step, the adhering unit, and the working device or the inspection device are moved in the traveling direction of the device by driving the horizontal reciprocation units while maintaining the state that the double-acting leg members are strongly pressed against the object surface;

as a fourth step, the double-acting leg members are separated from the object surface by the action of the vertical reciprocation units and are returned to the state immediately before the first step; and

the operations of the first to fourth steps are repeated thereafter, by which the device adhering to the object surface travels intermittently along the object surface while working on the object surface or obtaining information from the same.

In order to solve the above-mentioned problem, according to the first invention related to this invention, “a device capable of adhering to an object surface and traveling therealong” as described in Claim 5, for example, is provided.

Namely, the device capable of adhering to the object surface and traveling therealong comprises:

an adhering unit adhering to the object surface by the action of magnetic force;

horizontal reciprocation units respectively arranged on right and left sides of the adhering unit with respect to the moving direction thereof, and capable of reciprocating in a front-back direction of the moving direction;

vertical reciprocation units mounted on each of the horizontal reciprocation units and capable of reciprocating in the direction intersecting with the object surface;

double-acting leg members made of a material having a large friction coefficient like a polyurethane, respectively mounted on the vertical reciprocation units, and capable of reciprocating in the direction intersecting with the object surface;

a working device working on the object surface to jet a surface treating material, etc., or an inspection device obtaining information from the object surface to inspect the object surface, etc.; and a second horizontal reciprocation unit allowing the working device or the inspection device to reciprocate along the object surface and in the direction intersecting with the moving direction of the adhering unit;

in which, in order to enable the working device or the inspection device to perform scanning along the object surface and to enable the device adhering to the object surface to travel along the object surface;

as a first step, the working device or the inspection device performs outward or homeward scanning by the action of the second horizontal reciprocation unit, and at the same time, the double-acting leg members are moved in the traveling direction of the device by driving the horizontal reciprocation units while maintaining the state that the double-acting leg members are separated from the object surface;

as a second step, the double-acting leg members are strongly pressed against the object surface by the action of the vertical reciprocation units;

as a third step, the adhering unit, and the working device or the inspection device are moved in the traveling direction of the device by driving the horizontal reciprocation units while maintaining the state that the double-acting leg members are strongly pressed against the object surface;

as a fourth step, the double-acting leg members are separated from the object surface by the action of the vertical reciprocation units and are returned to the state immediately before the first step; and the operations of the first to fourth steps are repeated thereafter, by which the device adhering to the object surface travels intermittently along the object surface while working on the object surface or obtaining information from the same.

Effect of the Invention 1 (0007) The first invention related to this invention brings about the following effects.

Namely, in the “device capable of adhering by suction to an object surface and traveling therealong” by using negative pressure as described in claims 1 to 3, since an expensive displacement sensor like a servo motor or a rotary encoder, and an electric control system are not needed and the configuration and control are simplified, the manufacturing cost can be reduced. In addition, failures are reduced and the maintenance is facilitated as the configuration and control are simplified.

Further, heavy parts like wheels with a rotary shaft and a bearing, the servo motor with a reduction gear, a transmission mechanism transmitting the rotational driving force of the motor to the wheels, etc., are not needed. Thus, since the configuration is simple and the whole device is lightweight, the device is easily used and become more convenient.

Furthermore, since positional accuracy during intermittent traveling is improved, work quality can be improved when jetting a surface treatment material, etc., or inspection, etc., of the object surface.

In the “device capable of adhering to the object surface and traveling therealong” by using magnetic force as described in Claims 4 to 7, since an expensive displacement sensor like a servo motor or a rotary encoder, and an electric control system are not needed and the configuration and control are simplified, the manufacturing cost can be reduced. In addition, failures are reduced and the maintenance is facilitated as the configuration and control are simplified.

Further, heavy parts like wheels with a rotary shaft and a bearing, the servo motor with a reduction gear, a transmission mechanism transmitting the rotational driving force of the motor to the wheels, etc., are not needed. Thus, since the configuration is simple and the whole device is lightweight, the device is easily used and become more convenient.

Furthermore, since positional accuracy during intermittent traveling is improved, working quality can be improved upon jetting a surface treatment material, etc., or inspection, etc. of the object surface.

Other effects of the “device capable of adhering to the object surface and traveling therealong” by using magnetic force as described in Claims 4 to 7 are as follows.

Namely, it is not necessary to increase the size of the adhering unit as a shortcut method for providing the adhering unit with a required predetermined adhering force since the adhering unit is capable of moving along the object surface while maintaining the state that the adhering unit having magnetic force is in tight contact with the object surface, in other words, in the state that the adhering unit maintains its strong adhering force. Accordingly, in the device of this invention, the size and weight of the adhering unit can be reduced, wherefore the device is easily used and become more convenient.

### BEST MODE FOR CARRYING OUT THE INVENTION 1

Preferred embodiments of the device configured according to the first invention related to this invention will be explained in detail hereinafter referring to the accompanying drawings.

### Embodiment 1

FIG. 1 is a front view of the device of the preferred embodiment and the object surface 1 seen from the direction away from the object surface 1, showing the state that the device of the preferred embodiment adheres to the object surface 1, i.e., a wall surface, by negative pressure.

In FIG. 1, the device of the preferred embodiment (hereinafter referred to as “entire device”) travels upward and downward, and rotates clockwise and counterclockwise along the object surface 1. When members configuring the entire device are referred, a left-side part is referred to as left, and the right-side part is referred to as right.

The terms of “horizontal” and “vertical” in horizontal reciprocation units and vertical reciprocation units indicate horizontal movement or vertical movement with respect to the object surface 1.

The entire device will be explained hereinafter with reference to FIGS. 1 to 6.

The device shown in the Figs. is provided with a main frame 4. The main frame 4 is formed into an H-shape in FIG. 1.

The horizontal reciprocation units 5 respectively comprising rodless cylinders are respectively mounted on a left-side face and a right-side face of the main frame 4.

Vertical reciprocation unit frames 7 are mounted on motion members 501 of the horizontal reciprocation units 5.

Two vertical reciprocation units 6 comprising reciprocation cylinders are mounted on the vertical reciprocation unit frames 7.

Double-acting leg members 8 mainly made from polyurethane are mounted on front ends of piston rods of the vertical reciprocation units 6.

A negative pressure adhering unit 2 is mounted on a center part of the main frame 4 by the intermediary of a hollow rotary coupling means 9 in a rotatable manner along the object surface 1.

The negative pressure adhering unit 2 comprises a negative pressure adhering unit casing 201 having a cylindrical shape opening to the object surface 1, a negative pressure adhering unit seal 202 formed into a ring-like shape using polyurethane as its material and flared toward the object surface 1 like a trumpet, and negative pressure adhering unit fixing legs 203 mainly made from polyurethane.

The negative pressure adhering unit fixing legs 203 are the members for keeping a gap between the object surface 1 and an end part of the negative pressure adhering unit casing 201 constant when the gap is minimum.

A suction hose joint 10 is fitted to the hollow rotary coupling means 9.

A negative pressure generating means (not shown) like a vacuum pump is connected to the suction hose joint 10 by the intermediary of a suction hose (not shown).

A work frame 15 is welded to an upper end of the main frame 4.

A second horizontal reciprocation unit 16 comprising the rodless cylinder is mounted on the work frame 15.

A polishing and cleaning material blast nozzle 17 is mounted on a motion member 1601 of the second horizontal reciprocation unit 16 by the intermediary of a nozzle mounting member 1602.

A polishing and cleaning material pressure-feeding device (not shown) is connected to the polishing and cleaning material blast nozzle 17 by the intermediary of a polishing and cleaning material pressure-feeding blast hose 18.

A working device like a coating gun or a thermal spraying gun working on the object surface, or a sensor obtaining information from the object surface like an ultrasonic flaw detector can be mounted on the motion member 1601 of the second horizontal reciprocation unit 16 instead of the polishing and cleaning material blast nozzle 17.

Operation and effects of the above-mentioned device will be explained hereinafter.

When the negative pressure generating means (not shown) is energized, the atmosphere-like fluid in the negative pressure adhering unit 2 is discharged to the outside through the suction hose joint 10 and the suction hose (not shown), and the inside of the negative pressure adhering unit 2 is decompressed as required.

When the inside of the negative pressure adhering unit 2 is decompressed, the entire device adheres to the object surface 1 by the pressure of the surrounding fluid like the atmosphere acting on the negative pressure adhering unit 2 due to the difference in fluid pressure between the inside and the outside of the negative pressure adhering unit 2.

When the pressure inside the negative pressure adhering unit 2 is maintained at a required pressure, the negative pressure adhering unit seal 202 is brought into tight contact to the object surface 1 due to the difference in pressure between the inside and the outside of the negative pressure adhering unit 2. Accordingly, the fluid outside the negative pressure adhering unit 2 is prevented from flowing inside to the utmost.

Mixed fluid of the polishing and cleaning material and the compressed air, or mixed fluid of the polishing and cleaning material and high-pressure water is jetted powerfully from the polishing and cleaning material blast nozzle 17 to the object surface 1 so that rust, degraded paint or the like adhering to the object surface 1 can be removed.

The polishing and cleaning material blast nozzle 17 reciprocates in a direction crossing the traveling direction of the entire device by the action of the second horizontal reciprocation unit 16.

Steps for scanning the object surface 1 by the polishing and cleaning material blast nozzle 17 and traveling of the entire device along the object surface 1 will be explained below with reference to FIGS. 7 to 11.

In the meantime, FIG. 11 shows a state of the device immediately before the first step. In FIGS. 7 to 11, the entire device travels downward. A large arrow shows the moving direction and the moving distance of each member in the corresponding steps.

A double circle shows the double-acting leg members 8 or the fixing legs 203 strongly pressed against the object surface 1.

In FIGS. 8 and 9, the fixing legs 203 is separated from the object surface 1 since the double-acting leg members 8 are strongly pressed against the object surface 1, however, the fixing legs 203 is not necessarily separated therefrom. Namely, the friction force between the fixing legs 203 and the object surface 1 is reduced because the double-acting leg members 8 are strongly pressed against the object surface 1. Thus, when the negative pressure adhering unit with the fixing legs 203 can move along the object surface 1 while maintaining the state that the negative pressure adhering unit adheres to the object surface 1, the purpose of this invention is achieved.

First, in the first step shown in FIG. 7, the polishing and cleaning material blast nozzle 17 moves from right to left.

At the same time, the double-acting leg members 8 are moved in the traveling direction of the entire device, while maintaining the state of separation from the object surface 1, by driving of the horizontal reciprocation units 5.

A circle drawn by alternate long and two short dashed lines and surrounding the polishing and cleaning material blast nozzle 17 shows the area of the object surface 1 where the polishing and cleaning material is jetted.

Movement of the polishing and cleaning material blast nozzle 17 from right left is referred to as outward movement of the polishing and cleaning material blast nozzle 17.

In the meantime, in the first step shown in FIG. 7, the negative pressure adhering unit fixing legs 203 are strongly pressed against the object surface 1, while the double-acting leg members 8 are separated from the object surface 1.

In the second step shown in FIG. 8, the negative pressure adhering unit fixing legs 203 are separated from the object surface 1, while the double-acting leg members 8 are strongly pressed against the object surface 1.

In the third step shown in FIG. 9, the negative pressure adhering unit provided with the fixing legs 203 moves downward along the object surface 1 while maintaining the state of adhering to the object surface 1, and the polishing and cleaning material blast nozzle 17 also moves downward simultaneously.

In the meantime, in the third step shown in FIG. 9, the negative pressure adhering unit fixing legs 203 are separated from the object surface 1, while the double-acting leg members 8 are strongly pressed against the object surface 1.

In the fourth step shown in FIG. 10, the negative pressure adhering unit fixing legs 203 are strongly pressed against the object surface 1, while the double-acting leg members 8 are separated from the object surface 1.

When the fourth step is completed, the above-mentioned first to fourth steps are repeated except for the working direction of the polishing and cleaning material blast nozzle 17.

In the meantime, as for the working direction of the polishing and cleaning material blast nozzle 17, in the first step, the first step of outward movement of the polishing and cleaning material blast nozzle 17 from right to left and the first step of homeward movement of the same from left to right are alternately repeated.

In the device shown in FIGS. 1 to 11, when the horizontal reciprocation unit 5 and the vertical reciprocation unit 6 on the left side are allowed to travel and move downward, and the horizontal reciprocation unit 5 and the vertical reciprocation units 6 on the right side are allowed to travel and move upward, for example, the entire device rotationally travels counter-clockwise around the rotary coupling means 9, serving as a central axis, and along the object surface 1.

Upon the rotational traveling, the negative pressure adhering unit 2 does not rotate along the object surface 1 due to the action of the rotary coupling means 9. Namely, friction force is generated between the negative pressure adhering unit seal 202 and the object surface 1, however, the friction force between the negative pressure adhering unit seal 202 and the object surface 1 does not hinder rotational traveling of the entire device upon the above-mentioned rotational traveling, which is very favorable for achieving rotational traveling with high positioning accuracy.

Second preferred embodiment of the device configured according to the first invention related to this invention will be explained hereinafter with reference to FIGS. 12 and 13.

The device shown in FIGS. 12 and 13 is the one in which an adhering unit of the device shown in FIGS. 1 to 11 acting by the action of negative pressure is replaced with an adhering unit acting by the action of magnetic force.

In the device shown in FIGS. 12 and 13, the polishing and cleaning material blast nozzle 17 scans the object surface 1, and the entire device travels along the objet surface 1. Explanation on these steps is skipped here since the steps are similar to those in the device shown in FIGS. 1 to 11.

However, in the device shown in FIGS. 12 and 13, a magnetically adhering unit 3 is always in tight contact with the object surface 1 irrespective of the state of the double-acting leg members 8. Namely, since the double-acting leg members 8 are strongly pressed against the object surface 1, the friction force between the magnetically adhering unit 3 and the object surface 1 is reduced. Accordingly, when the magnetically adhering unit 3 can move along the object surface 1 while maintaining the state of adhering to the object surface 1, the purpose of this invention is achieved.

In the meantime, as shown in FIG. 13, provided that the magnetically adhering unit 3 has a fluid blast nozzle 301, a fluid blast pipe member 302 and a fluid blast hose 303, when a high-pressure fluid is allowed to flow in the gap between the magnetically adhering unit 3 and the object surface 1 upon moving of the magnetically adhering unit 3 along the object surface 1 while maintaining the state of adhering to the object surface 1, the friction force between the magnetically adhering unit 3 and the object surface 1 can be reduced more effectively.

The above-mentioned device of the preferred embodiment of the first invention related to this invention brings about the following effects.

Namely, in the “device capable of adhering by suction to an object surface and traveling therealong” by using negative pressure as described in Claims 1 to 3, since an expensive displacement sensor like a servo motor or a rotary encoder, and an electric control system are not needed, and the configuration and control are simplified, the manufacturing cost can be reduced. In addition, failures are reduced and the maintenance is facilitated as the configuration and control are simplified.

Further, heavy parts like wheels with a rotary shaft and a bearing, the servo motor with a reduction gear, a transmission mechanism transmitting the rotational driving force of the motor to the wheels, etc., are not needed. Thus, since the configuration is simple and the whole device is lightweight, the device is easily used and become more convenient.

Furthermore, since positional accuracy during intermittent traveling is improved, work quality can be improved when jetting a surface treatment material, etc., or inspection, etc., of the object surface.

In the “device capable of adhering to the object surface and traveling therealong” by using magnetic force as described in Claims 4 to 7, since an expensive displacement sensor like a servo motor or a rotary encoder, and an electric control system are not needed, and the configuration and control are simplified, the manufacturing cost can be reduced. In addition, failures are reduced and the maintenance is facilitated as the configuration and control are simplified.

Further, heavy parts like wheels with a rotary shaft and a bearing, the servo motor with a reduction gear, a transmission mechanism transmitting the rotational driving force of the motor to the wheels, etc., are not needed. Thus, since the configuration is simple and the whole device is lightweight, the device is easily used and become more convenient.

Furthermore, since positional accuracy during intermittent traveling is improved, working quality can be improved upon jetting a surface treatment material, etc., or inspection, etc., of the object surface.

Other effects of the “device capable of adhering to the object surface and traveling therealong” by using magnetic force as described in Claims 4 to 7 are as follows.

Namely, it is not necessary to increase the size of the adhering unit as a shortcut method for providing the adhering unit with a required predetermined adhering force since the adhering unit is capable of moving along the object surface while maintaining the state that the adhering unit having magnetic force is in tight contact with the object surface, in other words, in the state that the adhering unit maintains its strong adhering force. Accordingly, in the device of this invention, the size and weight of the adhering unit can be reduced, wherefore the device is easily used and become more convenient.

Preferred embodiments of the device of the first invention related to this invention are explained hereinbefore, however, various embodiments of the device of this invention other than the above-mentioned preferred embodiments can be conceived according to the scope of the claims of the invention.

In the meantime, the preferred embodiments of the device of this invention have been explained on the premise that the device of this invention exists on the object surface in the atmosphere. However, the device of this invention can also be applied even in water. As for the negative pressure generating means in this case, a water pump or a water-driven ejector can be used instead of a vacuum pump.

### Means to Solve the Problem 2

In order to solve the above-mentioned problem, according to the second invention related to this invention, the “device capable of adhering to an object surface and traveling therealong” as described in Claim 9, for example, is provided.

Namely, the device capable of adhering to the object surface and capable of traveling therealong comprises:

an adhering unit adhering to the object surface by the action of negative pressure;

horizontal reciprocation units respectively arranged on right and left sides of the adhering unit with respect to the moving direction thereof, and capable of reciprocating in a front-back direction of the moving direction;

vertical reciprocation units respectively mounted on the horizontal reciprocation units and capable of reciprocating in the direction intersecting with the object surface;

double-acting leg members made of a material having a large friction coefficient like a polyurethane, respectively mounted on the vertical reciprocation units, and capable of reciprocating in the direction intersecting with the object surface;

a working device working on the object surface to jet a surface treating material, etc., or an inspection device obtaining information from the object surface to inspect the object surface, etc.; and

a second horizontal reciprocation unit enabling the working device or the inspection device to reciprocate along the object surface and in the direction intersecting with the moving direction of the adhering unit;

in which, in order to enable the working device or the inspection device to perform scanning along the object surface and to enable the device adhering to the object surface to travel along the object surface;

as a first step, the working device or the inspection device starts or continues outward or homeward scanning by the action of the second horizontal reciprocation unit, and at the same time, the double-acting leg members are moved in the traveling direction of the device by driving the horizontal reciprocation units while maintaining the state that the double-acting leg members are separated from the object surface;

as a second step, the double-acting leg members are strongly pressed against the object surface by the action of the vertical reciprocation units, and at the same time, the working device or the inspection device continues and completes the outward or homeward scanning;

as a third step, the adhering unit, and the working device or the inspection device are moved in the traveling direction of the device by driving the horizontal reciprocation units while maintaining the state that the double-acting leg members are strongly pressed against the object surface;

as a fourth step, the double-acting leg members are separated from the object surface by the action of the vertical reciprocation units, and at the same time, the working device or the inspection device starts outward or homeward scanning, and returns to the state immediately before the first step; and

the operations of the first to fourth steps are repeated thereafter, by which the device adhering to the object surface travels intermittently along the object surface while working on the object surface or obtaining information from the same.

In order to solve the above-mentioned problem, according to the second invention related to this invention, the “device capable of adhering to an object surface and traveling therealong” as described in Claim 12, for example, is provided.

Namely, the device capable of adhering to the object surface and capable of traveling therealong comprises:

an adhering unit adhering to the object surface by the action of magnetic force;

horizontal reciprocation units respectively arranged on right and left sides of the adhering unit with respect to the moving direction thereof, and capable of reciprocating in a front-back direction of the moving direction;

vertical reciprocation units mounted on each of the horizontal reciprocation units and capable of reciprocating in the direction intersecting with the object surface;

double-acting leg members made of a material having a large friction coefficient like a polyurethane, respectively mounted on the vertical reciprocation units, and capable of reciprocating in the direction intersecting with the object surface;

a working device working on the object surface to jet a surface treating material, etc., or an inspection device obtaining information from the object surface to inspect the object surface, etc.; and

a second horizontal reciprocation unit allowing the working device or the inspection device to reciprocate along the object surface and in the direction intersecting with the moving direction of the adhering unit;

in which, in order to enable the working device or the inspection device to perform scanning along the object surface and to enable the device adhering to the object surface to travel along the object surface;

as a first step, the working device or the inspection device performs outward or homeward scanning by the action of the second horizontal reciprocation unit, and at the same time, the double-acting leg members are moved in the traveling direction of the device by driving the horizontal reciprocation units while maintaining the state that the double-acting leg members are separated from the object surface;

as a second step, the double-acting leg members are strongly pressed against the object surface by the action of the vertical reciprocation units;

as a third step, the adhering unit, and the working device or the inspection device are moved in the traveling direction of the device by driving the horizontal reciprocation units while maintaining the state that the double-acting leg members are strongly pressed against the object surface;

as a fourth step, the double-acting leg members are separated from the object surface by the action of the vertical reciprocation units and are returned to the state immediately before the first step; and the operations of the first to fourth steps are repeated thereafter, by which the device adhering to the object surface travels intermittently along the object surface while working on the object surface or obtaining information from the same.

### Effect of the Invention 2

The second invention related to this invention brings about the following effects.

Namely, in the “device capable of adhering to the object surface and traveling therealong” by using negative pressure as described in Claims 8 to 10, since an expensive displacement sensor like a servo motor or a rotary encoder, and an electric control system are not needed and the configuration and control are simplified, the manufacturing cost can be reduced. In addition, failures are reduced and the maintenance is facilitated as the configuration and control are simplified.

Further, heavy parts like wheels with a rotary shaft and a bearing, the servo motor with a reduction gear, a transmission mechanism transmitting the rotational driving force of the motor to the wheels, etc., are not needed. Thus, since the configuration is simple and the whole device is lightweight, the device is easily used and become more convenient.

Furthermore, since positional accuracy during intermittent traveling is improved, work quality can be improved when jetting a surface treatment material, etc., or inspection, etc. of the object surface.

In the “device capable of adhering to the object surface and travelling therealong” by using magnetic force as described in Claims 11 to 14, since an expensive displacement sensor like a servo motor or a rotary encoder, and an electric control system are not needed and the configuration and control are simplified, the manufacturing cost can be reduced. In addition, failures are reduced and the maintenance is facilitated as the configuration and control are simplified.

Further, heavy parts like wheels with a rotary shaft and a bearing, the servo motor with a reduction gear, a transmission mechanism transmitting the rotational driving force of the motor to the wheels, etc., are not needed. Thus, since the configuration is simple and the whole device is lightweight, the device is easily used and become more convenient.

Furthermore, since positional accuracy during intermittent traveling is improved, work quality can be improved when jetting a surface treatment material, etc., or inspection, etc. of the object surface.

Other advantages of the device capable of adhering to the object surface by magnetic force and traveling therealong described in Claims 11 to 14 are as follows.

Namely, it is not necessary to increase the size of the adhering unit as a shortcut method for providing the adhering unit with a required predetermined adhering force since the adhering unit is capable of moving along the object surface while maintaining the state that the adhering unit having magnetic force is in tight contact with the object surface, in other words, in the state that the adhering unit maintains its strong adhering force. Accordingly, in the device of this invention, the size and weight of the adhering unit can be reduced, wherefore the device is easily used and become more convenient.

### BEST MODE FOR CARRYING OUT THE INVENTION 2

Preferred embodiments of the device configured according to the second invention related to this invention are explained in more detail hereinafter referring to the accompanying drawings.

### Embodiment 2

FIG. 1 is a front view of the device of the preferred embodiment and the object surface 1 seen from the direction away from the object surface 1 to show the state in which the device of the preferred embodiment adheres to an object surface 1, being a wall surface, by negative pressure.

In FIG. 1, the device of the preferred embodiment (referred to as the “entire device” hereinafter) travels upward and downward, and rotates clockwise or counter-clockwise along the object surface 1. When referring to the parts comprising the entire device, a left-side part is referred to as “left” and the right-side part is referred to as “right”.

The expressions of “horizontal” and “vertical” in a horizontal reciprocation unit and a vertical reciprocation unit respectively indicates horizontal action and vertical action with regard to the object surface 1.

The entire device will be explained hereinafter with reference to FIGS. 1 to 6.

The device shown in the Figs. is provided with a main frame 4. The main frame 4 is formed into an H-shape in FIG. 1.

The horizontal reciprocation units 5 respectively comprising rodless cylinders are respectively mounted on a left-side face and a right-side face of the main frame 4.

Vertical reciprocation unit frames 7 are mounted on motion members 501 of the horizontal reciprocation units 5.

Two vertical reciprocation units 6 comprising reciprocation cylinders are mounted on the vertical reciprocation unit frames 7.

Double-acting leg members 8 mainly made from polyurethane are mounted on front ends of piston rods of the vertical reciprocation units 6.

A negative pressure adhering unit 2 is mounted on a center part of the main frame 4 by the intermediary of a hollow rotary coupling means 9 in a rotatable manner along the object surface 1.

The negative pressure adhering unit 2 comprises a negative pressure adhering unit casing 201 having a cylindrical shape opening to the object surface 1, a negative pressure adhering unit seal 202 formed into a ring-like shape using polyurethane as its material and flared toward the object surface 1 like a trumpet, and negative pressure adhering unit fixing legs 203 mainly made from polyurethane.

The negative pressure adhering unit fixing legs 203 are the members for keeping a gap between the object surface 1 and an end part of the negative pressure adhering unit casing 201 constant when the gap is minimum.

A suction hose joint 10 is fitted to the hollow rotary coupling means 9.

A negative pressure generating means (not shown) like a vacuum pump is connected to the suction hose joint 10 by the intermediary of a suction hose (not shown).

A work frame 15 is welded to an upper end of the main frame 4.

A second horizontal reciprocation unit 16 comprising the rodless cylinder is mounted on the work frame 15.

A polishing and cleaning material blast nozzle 17 is mounted on a motion member 1601 of the second horizontal reciprocation unit 16 by the intermediary of a nozzle mounting member 1602.

A polishing and cleaning material pressure-feeding device (not shown) is connected to the polishing and cleaning material blast nozzle 17 by the intermediary of a polishing and cleaning material pressure-feeding blast hose 18.

A working device like a coating gun or a thermal spraying gun working on the object surface, or a sensor obtaining information from the object surface like an ultrasonic flaw detector can be mounted on the motion member 1601 of the second horizontal reciprocation unit 16 instead of the polishing and cleaning material blast nozzle 17.

Operation and effects of the above-mentioned device will be explained hereinafter.

When the negative pressure generating means (not shown) is energized, the atmosphere-like fluid in the negative pressure adhering unit 2 is discharged to the outside through the suction hose joint 10 and the suction hose (not shown), and the inside of the negative pressure adhering unit 2 is decompressed as required.

When the inside of the negative pressure adhering unit 2 is decompressed, the entire device adheres to the object surface 1 by the pressure of the surrounding fluid like the atmosphere acting on the negative pressure adhering unit 2 due to the difference in fluid pressure between the inside and the outside of the negative pressure adhering unit 2.

When the pressure inside the negative pressure adhering unit 2 is maintained at a required pressure, the negative pressure adhering unit seal 202 is brought into tight contact to the object surface 1 due to the difference in pressure between the inside and the outside of the negative pressure adhering unit 2. Accordingly, the fluid outside the negative pressure adhering unit 2 is prevented from flowing inside to the utmost.

Mixed fluid of the polishing and cleaning material and the compressed air, or mixed fluid of the polishing and cleaning material and high-pressure water is jetted powerfully from the polishing and cleaning material blast nozzle 17 to the object surface 1 so that rust, degraded paint or the like adhering to the object surface 1 can be removed.

The polishing and cleaning material blast nozzle 17 reciprocates in a direction crossing the traveling direction of the entire device by the action of the second horizontal reciprocation unit 16.

(0031) Steps for scanning the object surface 1 by the polishing and cleaning material blast nozzle 17 and traveling of the entire device along the object surface 1 will be explained below with reference to FIGS. 7 to 11.

In the meantime, FIG. 11 shows a state of the device immediately before the first step. In FIGS. 7 to 11, the entire device travels downward. A large arrow shows the moving direction and the moving distance of each member in the corresponding steps.

Each of FIGS. 7 to 10 shows a final position of each part in each step.

A double circle shows the double-acting leg members 8 or the fixing legs 203 strongly pressed against the object surface 1.

In FIGS. 8 and 9, the fixing legs 203 is separated from the object surface 1 since the double-acting leg members 8 are strongly pressed against the object surface 1, however, the fixing legs 203 is not necessarily separated therefrom. Namely, the friction force between the fixing legs 203 and the object surface 1 is reduced because the double-acting leg members 8 are strongly pressed against the object surface 1. Thus, when the negative pressure adhering unit with the fixing legs 203 can move along the object surface 1 while maintaining the state that the negative pressure adhering unit adheres to the object surface 1, the purpose of this invention is achieved.

The steps mentioned below for scanning the object surface 1 by the polishing and cleaning material blast nozzle 17 and allowing the entire device to travel along the object surface 1 are to explain the steps for minimizing the suspension time upon switching-over between the outward traveling and homeward traveling of the reciprocating polishing and cleaning material blast nozzle 17.

First, in the first step shown in FIG. 7, the polishing and cleaning material blast nozzle 17 moves from right to left.

At the same time, the double-acting leg members 8 are moved in the traveling direction of the entire device, while maintaining the state of separation from the object surface 1, by driving the horizontal reciprocation units 5.

A circle drawn by alternate long and two short dashed lines and surrounding the polishing and cleaning material blast nozzle 17 shows the area of the object surface 1 where the polishing and cleaning material is jetted.

Movement of the polishing and cleaning material blast nozzle 17 from right left is referred to as outward movement of the polishing and cleaning material blast nozzle 17.

In the meantime, in the first step shown in FIG. 7, the negative pressure adhering unit fixing legs 203 are strongly pressed against the object surface 1, while the double-acting leg members 8 are separated from the object surface 1.

In the second step shown in FIG. 8, the negative pressure adhering unit fixing legs 203 are separated from the object surface 1, while the double-acting leg members 8 are strongly pressed against the object surface 1.

At the same time, outward or homeward scanning by the working device or the inspection device is continued, and the movement is completed.

In the third step shown in FIG. 9, the negative pressure adhering unit provided with the fixing legs 203 moves downward along the object surface 1 while maintaining the state of adhering to the object surface 1, and the polishing and cleaning material blast nozzle 17 also moves downward at the same time.

In the meantime, in the third step shown in FIG. 9, the negative pressure adhering unit fixing legs 203 are separated from the object surface 1, while the double-acting leg members 8 are strongly pressed against the object surface 1.

In the fourth step shown in FIG. 10, the negative pressure adhering unit fixing legs 203 are strongly pressed against the object surface 1, while the double-acting leg members 8 are separated from the object surface 1.

At the same time, outward or homeward scanning by the working device or the inspection device starts.

When the fourth step is completed, the above-mentioned first to fourth steps are repeated except for the working direction of the polishing and cleaning material blast nozzle 17.

As for the working direction of the polishing and cleaning material blast nozzle 17, in the fourth and the first to second steps, the fourth and the first to second steps of outward movement of the polishing and cleaning material blast nozzle 17 from right to left, and the fourth and the first to second steps of homeward movement of the same from left to right are alternately repeated.

In the device shown in FIGS. 1 to 11, when the horizontal reciprocation unit 5 and the vertical reciprocation unit 6 on the left side are allowed to travel and move downward, and the horizontal reciprocation unit 5 and the vertical reciprocation units 6 on the right side are allowed to travel and move upward, for example, the entire device rotationally travels counter-clockwise around the rotary coupling means 9, serving as a central axis, and along the object surface 1.

Upon the rotational traveling, the negative pressure adhering unit 2 does not rotate along the object surface 1 due to the action of the rotary coupling means 9. Namely, friction force is generated between the negative pressure adhering unit seal 202 and the object surface 1, however, the friction force between the negative pressure adhering unit seal 202 and the object surface 1 does not hinder rotational traveling of the entire device upon the above-mentioned rotational traveling, which is very favorable for achieving rotational traveling with high positioning accuracy.

Second preferred embodiment of the device configured according to the second invention related to this invention will be explained hereinafter with reference to FIGS. 12 and 13.

The device shown in FIGS. 12 and 13 is the one in which an adhering unit of the device shown in FIGS. 1 to 11 acting by the action of negative pressure is replaced with an adhering unit acting by the action of magnetic force.

In the device shown in FIGS. 12 and 13, the polishing and cleaning material blast nozzle 17 scans the object surface 1, and the entire device travels along the objet surface 1. Explanation on these steps is skipped here since the steps are similar to those in the device shown in FIGS. 1 to 11.

However, in the device shown in FIGS. 12 and 13, a magnetically adhering unit 3 is always in tight contact with the object surface 1 irrespective of the state of the double-acting leg members 8. Namely, since the double-acting leg members 8 are strongly pressed against the object surface 1, the friction force between the magnetically adhering unit 3 and the object surface 1 is reduced. Accordingly, when the magnetically adhering unit 3 can move along the object surface 1 while maintaining the state of adhering to the object surface 1, the purpose of this invention is achieved.

In the meantime, as shown in FIG. 13, provided that the magnetically adhering unit 3 has a fluid blast nozzle 301, a fluid blast pipe member 302 and a fluid blast hose 303, when a high-pressure fluid is allowed to flow in the gap between the magnetically adhering unit 3 and the object surface 1 upon moving of the magnetically adhering unit 3 along the object surface 1 while maintaining the state of adhering to the object surface 1, the friction force between the magnetically adhering unit 3 and the object surface 1 can be reduced more effectively.

The above-mentioned device of the preferred embodiment of the second invention related to this invention brings about the following effects.

Namely, in the “device capable of adhering by suction to an object surface and traveling therealong” by using negative pressure as described in Claims 8 to 10, since an expensive displacement sensor like a servo motor or a rotary encoder, and an electric control system are not needed, and the configuration and control are simplified, the manufacturing cost can be reduced. In addition, failures are reduced and the maintenance is facilitated as the configuration and control are simplified.

Further, heavy parts like wheels with a rotary shaft and a bearing, the servo motor with a reduction gear, a transmission mechanism transmitting the rotational driving force of the motor to the wheels, etc., are not needed. Thus, since the configuration is simple and the whole device is lightweight, the device is easily used and become more convenient.

Furthermore, since positional accuracy during intermittent traveling is improved, work quality can be improved when jetting a surface treatment material etc., or inspection, etc. of the object surface.

In the “device capable of adhering to the object surface and traveling therealong” by using magnetic force as described in claims 11 to 14, since an expensive displacement sensor like a servo motor or a rotary encoder, and an electric control system are not needed, and the configuration and control are simplified, the manufacturing cost can be reduced. In addition, failures are reduced and the maintenance is facilitated as the configuration and control are simplified.

Further, heavy parts like wheels with a rotary shaft and a bearing, the servo motor with a reduction gear, a transmission mechanism transmitting the rotational driving force of the motor to the wheels, etc., are not needed. Thus, since the configuration is simple and the whole device is lightweight, the device is easily used and become more convenient.

Furthermore, since positional accuracy during intermittent traveling is improved, working quality can be improved upon jetting a surface treatment material, etc., or inspection, etc., of the object surface.

Other effects of the “device capable of adhering to the object surface and traveling therealong” by using magnetic force as described in Claims 11 to 14 are as follows.

Namely, it is not necessary to increase the size of the adhering unit as a shortcut method for providing the adhering unit with a required predetermined adhering force since the adhering unit is capable of moving along the object surface while maintaining the state that the adhering unit having magnetic force is in tight contact with the object surface, in other words, in the state that the adhering unit maintains its strong adhering force. Accordingly, in the device of this invention, the size and weight of the adhering unit can be reduced, wherefore the device is easily used and become more convenient.

Preferred embodiments of the device of the second invention related to this invention are explained hereinbefore, however, various embodiments of the device of this invention other than the above-mentioned preferred embodiments can be conceived according to the scope of the claims of the invention.

In the meantime, the preferred embodiments of the device of this invention have been explained on the premise that the device of this invention exists on the object surface in the atmosphere. However, the device of this invention can also be applied even in water. As for the negative pressure generating means in this case, a water pump or a water-driven ejector can be used instead of a vacuum pump.

### Means to Solve the Problems 3

In order to solve the above-mentioned problems, according to the third invention related to this invention, “a device capable of adhering to an object surface and traveling therealong” as described in Claim 16, for example, is provided.

Namely, the device capable of adhering to an object surface and traveling therealong comprises:

an adhering unit adhering to an object surface by the action of negative pressure;

an X-axis horizontal reciprocation unit arranged on the adhering unit and capable of reciprocating in an X-axis direction of the two moving directions of the adhering unit moving along the object surface, i.e., the X-axis and a Y-axis directions of the moving directional axes perpendicular to each other;

Y-axis horizontal reciprocation units respectively arranged at two ends of the X-axis horizontal reciprocation unit and capable of reciprocating in the Y-axis direction;

vertical reciprocation units mounted on each of the Y-axis horizontal reciprocation units and capable of reciprocating in the direction intersecting with the object surface; and

double-acting leg members made of a material having a large friction coefficient like a polyurethane, respectively mounted on the vertical reciprocation units and capable of reciprocating in the direction intersecting with the object surface;

a working device working on the object surface to jet a surface treating material, etc., or an inspection device obtaining information from the object surface to inspect the object surface, etc.; and

a second X-axis horizontal reciprocation unit enabling the working device or the inspection device to reciprocate along the object surface and in the X-axis direction;

in which, in order to enable the working device or the inspection device to perform scanning along the object surface and to enable the device adhering to the object surface to travel along the object surface and in the Y-axis direction;

as a first step, the working device or the inspection device performs outward or homeward scanning by the action of the second X-axis horizontal reciprocation unit, and the double-acting leg members are moved in the traveling direction of the device by driving the horizontal reciprocation units while maintaining the state that the double-acting leg members are separated from the object surface;

as a second step, the double-acting leg members are strongly pressed against the object surface by the action of the vertical reciprocation units;

as a third step, the adhering unit, and the working device or the inspection device are moved in the traveling direction of the device by driving the horizontal reciprocation units while maintaining the state that the double-acting leg members are strongly pressed against the object surface;

as a fourth step, the double-acting leg members are separated from the object surface by the action of the vertical reciprocation units and are returned to the state immediately before the first step; and the operations of the first to fourth steps are repeated thereafter, by which the device adhering to the object surface travels intermittently along the object surface while working on the object surface or obtaining information from the same.

In order to solve the above-mentioned problems, according to the third invention related to this invention, “a device capable of adhering to an object surface and traveling therealong” as described in Claim 19, for example, is provided.

Namely, the device capable of adhering to an object surface and traveling therealong comprises:

an adhering unit adhering to an object surface by the action of magnetic force;

an X-axis horizontal reciprocation unit arranged on the adhering unit and capable of reciprocating in an X-axis direction of the two moving directions of the adhering unit moving along the object surface, i.e., the X-axis and a Y-axis directions of the moving directional axes perpendicular to each other;

Y-axis horizontal reciprocation units respectively arranged at two ends of the X-axis horizontal reciprocation unit and capable of reciprocating in the Y-axis direction;

vertical reciprocation units mounted on each of the Y-axis horizontal reciprocation units and capable of reciprocating in the direction intersecting with the object surface;

double-acting leg members made of a material having a large friction coefficient like a polyurethane, respectively mounted on the vertical reciprocation units and capable of reciprocating in the direction intersecting with the object surface;

a working device working on the object surface to jet a surface treating material, etc., or an inspection device obtaining information from the object surface to inspect the object surface, etc.; and

a second X-axis horizontal reciprocation unit enabling the working device or the inspection device to reciprocate along the object surface and in the X-axis direction;

in which, in order to enable the working device or the inspection device to perform scanning along the object surface and to enable the device adhering to the object surface to travel along the object surface and in the Y-axis direction;

as a first step, the working device or the inspection device performs outward or homeward scanning by the action of the second X-axis horizontal reciprocation unit, and the double-acting leg members are moved in the traveling direction of the device by driving the horizontal reciprocation units while maintaining the state that the double-acting leg members are separated from the object surface;

as a second step, the double-acting leg members are strongly pressed against the object surface by the action of the vertical reciprocation units;

as a third step, the adhering unit, and the working device or the inspection device are moved in the traveling direction of the device by driving the horizontal reciprocation units while maintaining the state that the double-acting leg members are strongly pressed against the object surface;

as a fourth step, the double-acting leg members are separated from the object surface by the action of the vertical reciprocation units and are returned to the state immediately before the first step; and

the operations of the first to fourth steps are repeated thereafter, by which the device adhering to the object surface travels intermittently along the object surface while working on the object surface or obtaining information from the same.

### Effects of the Invention 3

The third invention related to this invention brings about the following effects.

Namely, in the “device capable of adhering to an object surface and capable of traveling therealong” by using a negative pressure as described in Claims 15 to 17, since an expensive displacement sensor like a servo motor or a rotary encoder, and an electric control system are not needed, and the configuration and control are simplified, the manufacturing cost can be reduced. In addition, failures are reduced and the maintenance is facilitated as the configuration and control are simplified.

Further, heavy parts like wheels with a rotary shaft and a bearing, the servo motor with a reduction gear, a transmission mechanism transmitting the rotational driving force of the motor to the wheels, etc., are not needed. Thus, since the configuration is simple and the whole device is lightweight, the device is easily used and become more convenient.

Furthermore, since positional accuracy during intermittent traveling is improved, work quality can be improved when jetting a surface treatment material, etc., or inspection, etc., of the object surface.

In the “device capable of adhering to the object surface and traveling therealong” by using magnetic force as described in Claims 18 to 21, since an expensive displacement sensor like a servo motor or a rotary encoder, and an electric control system are not needed, and the configuration and control are simplified, the manufacturing cost can be reduced. In addition, failures are reduced and the maintenance is facilitated as the configuration and control are simplified.

Further, heavy parts like wheels with a rotary shaft and a bearing, the servo motor with a reduction gear, a transmission mechanism transmitting the rotational driving force of the motor to the wheels, etc., are not needed. Thus, since the configuration is simple and the whole device is lightweight, the device is easily used and become more convenient.

Furthermore, since positional accuracy during intermittent traveling is improved, work quality can be improved when jetting a surface treatment material, etc., or inspection, etc., of the object surface.

Other effects of the “device capable of adhering to the object surface and traveling therealong” by using magnetic force as described in Claims 18 to 21 are as follows.

Namely, it is not necessary to increase the size of the adhering unit as a shortcut method for providing the adhering unit with a required predetermined adhering force since the adhering unit is capable of moving along the object surface while maintaining the state that the adhering unit having magnetic force is in tight contact with the object surface, in other words, in the state that the adhering unit maintains its strong adhering force. Accordingly, in the device of this invention, the size and weight of the adhering unit can be reduced, wherefore the device is easily used and become more convenient.

### BEST MODE FOR CARRYING OUT THE INVENTION 3

Preferred embodiments of the device configured according to the third invention related to this invention are explained in more detail hereinafter referring to the accompanying drawings.

### Embodiment 3

FIG. 14 is a front view of the device of the preferred embodiment and the object surface 1 seen from the direction away from the object surface 1 to show the state in which the device of the preferred embodiment adheres to an object surface 1, being a wall surface, by negative pressure.

In FIG. 14, the device of the preferred embodiment (referred to as the “entire device” hereinafter) travels upward and downward, and rotates clockwise or counter-clockwise along the object surface 1. When referring to the parts comprising the entire device, a left-side part is referred to as “left” and the right-side part is referred to as “right”.

In FIG. 14, a vertical axis is referred to as a Y-axis and a horizontal axis is referred to as an X-axis.

The expressions of “horizontal” and “vertical” in a horizontal reciprocation unit and a vertical reciprocation unit respectively indicates horizontal action and vertical action with regard to the object surface 1.

The entire device will be explained hereinafter with reference to FIGS. 14 to 19.

The device shown in the Figs. is provided with a main frame 4. The main frame 4 is formed into a plate-like shape in FIG. 14.

Motion members 1101 of X-axis horizontal reciprocation units 11 comprising rodless cylinders are respectively mounted on the upper and lower parts of the main frame 4.

Y-axis horizontal reciprocation units 5 comprising the rodless cylinders are respectively mounted on a left end part of the upper X-axis horizontal reciprocation unit 11 and a left end part of the lower X-axis horizontal reciprocation unit 11. Another set of the Y-axis horizontal reciprocation units 5 comprising the rodless cylinders are mounted on a right end part of the upper X-axis horizontal reciprocation unit 11 and a right end part of the lower X-axis horizontal reciprocation unit 11.

Vertical reciprocation unit frames 7 are mounted on the motion members 501 of the Y-axis horizontal reciprocation units 5.

Two vertical reciprocation units 6 comprising reciprocation cylinders are mounted on the vertical reciprocation unit frames 7.

Double-acting leg members 8 mainly made from polyurethane are mounted on front ends of piston rods of the vertical reciprocation units 6.

A negative pressure adhering unit 2 is mounted on a center part of the main frame 4 by the intermediary of a hollow rotary coupling means 9 in a rotatable manner along the object surface 1.

The negative pressure adhering unit 2 comprises a negative pressure adhering unit casing 201 having a cylindrical shape opening to the object surface 1, a negative pressure adhering unit seal 202 formed into a ring-like shape using polyurethane as its material and flared toward the object surface 1 like a trumpet, and negative pressure adhering unit fixing legs 203 mainly made from polyurethane.

The negative pressure adhering unit fixing legs 203 are the members for keeping a gap between the object surface 1 and an end part of the negative pressure adhering unit casing 201 constant when the gap is minimum.

A suction hose joint 10 is fitted to the hollow rotary coupling means 9.

A negative pressure generating means (not shown) like a vacuum pump is connected to the suction hose joint 10 by the intermediary of a suction hose (not shown).

A work frame 15 is welded to an upper end of the main frame 4.

A second X-axis horizontal reciprocation unit 16 comprising the rodless cylinder is mounted on the work frame 15.

A polishing and cleaning material blast nozzle 17 is mounted on a motion member 1601 of the second X-axis horizontal reciprocation unit 16 by the intermediary of a nozzle mounting member 1602.

A polishing and cleaning material pressure-feeding device (not shown) is connected to the polishing and cleaning material blast nozzle 17 by the intermediary of a polishing and cleaning material pressure-feeding blast hose 18.

A working device like a coating gun or a thermal spraying gun working on the object surface, or a sensor obtaining information from the object surface like an ultrasonic flaw detector can be mounted on the motion member 1601 of the second X-axis horizontal reciprocation unit 16 instead of the polishing and cleaning material blast nozzle 17.

Operation and effects of the above-mentioned device will be explained hereinafter.

When the negative pressure generating means (not shown) is energized, the atmosphere-like fluid in the negative pressure adhering unit 2 is discharged to the outside through the suction hose joint 10 and the suction hose (not shown), and the inside of the negative pressure adhering unit 2 is decompressed as required.

When the inside of the negative pressure adhering unit 2 is decompressed, the entire device adheres to the object surface 1 by the pressure of the surrounding fluid like the atmosphere acting on the negative pressure adhering unit 2 due to the difference in fluid pressure between the inside and the outside of the negative pressure adhering unit 2.

When the pressure inside the negative pressure adhering unit 2 is maintained at a required pressure, the negative pressure adhering unit seal 202 is brought into tight contact to the object surface 1 due to the difference in pressure between the inside and the outside of the negative pressure adhering unit 2. Accordingly, the fluid outside the negative pressure adhering unit 2 is prevented from flowing inside to the utmost.

Mixed fluid of the polishing and cleaning material and the compressed air, or mixed fluid of the polishing and cleaning material and high-pressure water is jetted powerfully from the polishing and cleaning material blast nozzle 17 to the object surface 1 so that rust, degraded paint or the like adhering to the object surface 1 can be removed.

The polishing and cleaning material blast nozzle 17 reciprocates in an X-axis direction intersecting with the Y-axis, which is a traveling direction of the entire device, by the action of the second X-axis horizontal reciprocation unit 16.

Steps for scanning the object surface 1 by the polishing and cleaning material blast nozzle 17 and traveling of the entire device along the object surface 1 will be explained below with reference to FIGS. 20 to 24.

In the meantime, FIG. 24 shows a state of the device immediately before the first step. In FIGS. 20 to 24, the entire device travels downward. A large arrow shows the moving direction and the moving distance of each member in the corresponding steps.

A double circle shows the double-acting leg members 8 or the fixing legs 203 strongly pressed against the object surface 1.

In FIGS. 21 and 22 the fixing legs 203 is separated from the object surface 1 since the double-acting leg members 8 are strongly pressed against the object surface 1, however, the fixing legs 203 is not necessarily separated therefrom. Namely, the friction force between the fixing legs 203 and the object surface 1 is reduced because the double-acting leg members 8 are strongly pressed against the object surface 1. Thus, when the negative pressure adhering unit with the fixing legs 203 can move along the object surface 1 while maintaining the state that the negative pressure adhering unit adheres to the object surface 1, the purpose of this invention is achieved.

First, in the first step shown in FIG. 20, the polishing and cleaning material blast nozzle 17 moves from right to left.

Further, the double-acting leg members 8 are moved in the traveling direction of the entire device, while maintaining the state of separation from the object surface 1, by driving of the horizontal reciprocation units 5.

A circle drawn by alternate long and two short dashed lines and surrounding the polishing and cleaning material blast nozzle 17 shows the area of the object surface 1 where the polishing and cleaning material is jetted.

Movement of the polishing and cleaning material blast nozzle 17 from right left is referred to as outward movement of the polishing and cleaning material blast nozzle 17.

In the meantime, in the first step shown in FIG. 20, the negative pressure adhering unit fixing legs 203 are strongly pressed against the object surface 1, while the double-acting leg members 8 are separated from the object surface 1.

In the second step shown in FIG. 21, the negative pressure adhering unit fixing legs 203 are separated from the object surface 1, while the double-acting leg members 8 are strongly pressed against the object surface 1.

In the third step shown in FIG. 22, the negative pressure adhering unit provided with the fixing legs 203 moves downward along the object surface 1 while maintaining the state of adhering to the object surface 1, and the polishing and cleaning material blast nozzle 17 also moves downward simultaneously.

In the meantime, in the third step shown in FIG. 22, the negative pressure adhering unit fixing legs 203 are separated from the object surface 1, while the double-acting leg members 8 are strongly pressed against the object surface 1.

In the fourth step shown in FIG. 23, the negative pressure adhering unit fixing legs 203 are strongly pressed against the object surface 1, while the double-acting leg members 8 are separated from the object surface 1.

When the fourth step is completed, the above-mentioned first to fourth steps are repeated except for the working direction of the polishing and cleaning material blast nozzle 17.

In the meantime, as for the working direction of the polishing and cleaning material blast nozzle 17, in the first step, the first step of outward movement of the polishing and cleaning material blast nozzle 17 from right to left and the first step of homeward movement of the same from left to right are alternately repeated.

Steps of traveling of the entire device along the object surface 1 in the direction of the X-axis will be explained hereinafter with reference to FIGS. 27 to 31.

FIG. 27 shows the state of the device immediately before the first step.

In FIGS. 27 to 31, traveling direction of the entire device is from right to left. A large arrow shows the moving direction and moving distance of respective members in the corresponding steps.

A double circle shows the double-acting leg members 8 or the fixing legs 203 strongly pressed against the object surface 1.

In FIGS. 21 and 22, the fixing legs 203 is separated from the object surface 1 since the double-acting leg members 8 are strongly pressed against the object surface 1, however, the fixing legs 203 is not necessarily separated therefrom. Namely, the friction force between the fixing legs 203 and the object surface 1 is reduced because the double-acting leg members 8 are strongly pressed against the object surface 1. Thus, when the negative pressure adhering unit with the fixing legs 203 can move along the object surface 1 while maintaining the state that the negative pressure adhering unit adheres to the object surface 1, the purpose of this invention is achieved.

First, in the first step shown in FIG. 28, the double-acting leg members 8 move from right and left by driving the X-axis horizontal reciprocation unit 11 while maintaining the state that the double-acting leg members 8 are separated from the object surface 1. In the meantime, in the first step shown in FIG. 28, the negative pressure adhering unit fixing legs 203 are strongly pressed against the object surface 1, while the double-acting leg members 8 are separated from the object surface 1.

In the second step shown in FIG. 29, the negative pressure adhering unit fixing legs 203 are separated from the object surface 1, while the double-acting leg members 8 are strongly pressed against the object surface 1.

In the third step shown in FIG. 30, the negative pressure adhering unit having the fixing leg members 203 moves to the left along the object surface 1 while maintaining the state of adherence to the object surface 1.

In the meantime, in the third step shown in FIG. 30, the negative pressure adhering unit fixing leg members 203 are separated from the object surface 1, while the double-acting leg members 8 are strongly pressed against the object surface 1.

In the fourth step shown in FIG. 31, the negative pressure adhering unit fixing leg members 203 are strongly pressed against the object surface 1, while the double-acting leg members 8 are separated from the object surface 1.

When the fourth step is finished, the above-mentioned first to fourth steps are repeated.

As mentioned above, since the device of this invention is capable of traveling also in the X-axis direction to change traveling lanes in addition to traveling in the Y-axis direction while working along the object surface, efficient work can be materialized.

In the device shown in FIGS. 14 to 24, when the Y-axis horizontal reciprocation unit 5 and the vertical reciprocation unit 6 on the left side are allowed to travel downward, and the Y-axis horizontal reciprocation unit 5 and the vertical reciprocation unit 6 on the right side are allowed to travel upward, for example, the entire device rotationally travels counter-clockwise around a rotary coupling means 9 serving as a central axis, and along the object surface 1. During the rotational traveling, the negative pressure adhering unit 2 does not rotate along the object surface 1 due to the action of the rotary coupling means 9.

Namely, though friction force is generated between the negative pressure adhering unit seal 202 and the object surface 1, the friction force between the negative pressure adhering unit seal 202 and the object surface 1 does not hinder the rotational traveling of the entire device upon the above-mentioned rotational traveling. This is very favorable to achieve rotational traveling with high positional accuracy.

Second preferred embodiment of the device configured according to the third invention related to this invention will be explained hereinafter with reference to FIGS. 25 and 26.

The device shown in FIGS. 25 and 26 is the one in which an adhering unit of the device shown in FIGS. 14 to 24 acting by the action of negative pressure is replaced with an adhering unit acting by the action of magnetic force.

In the device shown in FIGS. 25 and 26, the polishing and cleaning material blast nozzle 17 scans the object surface 1, and the entire device travels along the objet surface 1. Explanation on these steps is skipped here since the steps are similar to those in the device shown in FIGS. 14 to 24.

However, in the device shown in FIGS. 25 and 26, a magnetically adhering unit 3 is always in tight contact with the object surface 1 irrespective of the state of the double-acting leg members 8. Namely, since the double-acting leg members 8 are strongly pressed against the object surface 1, the friction force between the magnetically adhering unit 3 and the object surface 1 is reduced. Accordingly, when the magnetically adhering unit 3 can move along the object surface 1 while maintaining the state of adhering to the object surface 1, the purpose of this invention is achieved.

In the meantime, as shown in FIG. 26, provided that the magnetically adhering unit 3 has a fluid blast nozzle 301, a fluid blast pipe member 302 and a fluid blast hose 303, when a high-pressure fluid is allowed to flow in the gap between the magnetically adhering unit 3 and the object surface 1 upon moving of the magnetically adhering unit 3 along the object surface 1 while maintaining the state of adhering to the object surface 1, the friction force between the magnetically adhering unit 3 and the object surface 1 can be reduced more effectively.

The above-mentioned device of the preferred embodiment of the third invention related to this invention brings about the following effects.

Namely, in the “device capable of adhering to the object surface and traveling therealong” by using negative pressure as described in Claims 15 to 17, since an expensive displacement sensor like a servo motor or a rotary encoder, and an electric control system are not needed, and the configuration and control are simplified, the manufacturing cost can be reduced. In addition, failures are reduced and the maintenance is facilitated as the configuration and control are simplified.

Further, heavy parts like wheels with a rotary shaft and a bearing, the servo motor with a reduction gear, a transmission mechanism transmitting the rotational driving force of the motor to the wheels, etc., are not needed. Thus, since the configuration is simple and the whole device is lightweight, the device is easily used and become more convenient.

Furthermore, since positional accuracy during intermittent traveling is improved, working quality can be improved upon jetting a surface treatment material etc., or inspection etc. of the object surface.

In the “device capable of adhering to the object surface and traveling therealong” by using magnetic force as described in Claims 18 to 21, since an expensive displacement sensor like a servo motor or a rotary encoder, and an electric control system are not needed, and the configuration and control are simplified, the manufacturing cost can be reduced. In addition, failures are reduced and the maintenance is facilitated as the configuration and control are simplified.

Further, heavy parts like wheels with a rotary shaft and a bearing, the servo motor with a reduction gear, a transmission mechanism transmitting the rotational driving force of the motor to the wheels, etc., are not needed. Thus, since the configuration is simple and the whole device is lightweight, the device is easily used and become more convenient.

Furthermore, since positional accuracy during intermittent traveling is improved, working quality can be improved upon jetting a surface treatment material etc., or inspection etc. of the object surface.

Other effects of the “device capable of adhering to the object surface and traveling therealong” by using magnetic force as described in Claims 18 to 21 are as follows.

Namely, it is not necessary to increase the size of the adhering unit as a shortcut method for providing the adhering unit with a required predetermined adhering force since the adhering unit is capable of moving along the object surface while maintaining the state that the adhering unit having magnetic force is in tight contact with the object surface, in other words, in the state that the adhering unit maintains its strong adhering force. Accordingly, in the device of this invention, the size and weight of the adhering unit can be reduced, wherefore the device is easily used and become more convenient.

Preferred embodiments of the device of the third invention related to this invention are explained hereinbefore, however, various embodiments of the device of this invention other than the above-mentioned preferred embodiments can be conceived according to the scope of the claims of the invention.

In the meantime, the preferred embodiments of the device of this invention have been explained on the premise that the device of this invention exists on the object surface in the atmosphere. However, the device of this invention can also be applied even in water. As for the negative pressure generating means in this case, a water pump or a water-driven ejector can be used instead of a vacuum pump.

### INDUSTRIAL APPLICABILITY

The above-mentioned “device capable of adhering to the object surface and traveling therealong” can be conveniently used in various fields: as a cleaning device for removing foreign substances like dirt, rust, degraded coating or aquatic organisms clung to the object surface while adhering to the object surface by using negative pressure or magnetic force and moving along the object surface; or as an inspection device performing inspection like ultrasonic flaw detection of the object surface while adhering to the object surface by using negative pressure or magnetic force and moving along the object surface.

### BRIEF DESCRIPTION OF THE DRAWINGS

FIG. 1 is a front view showing a first preferred embodiment of the device configured according to this invention.

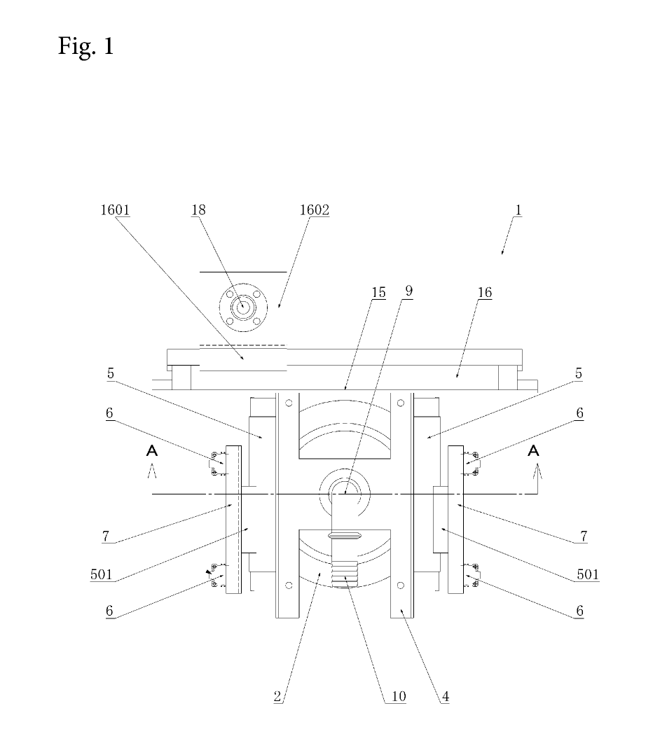

FIG. 2 is a right-side view of the device shown in FIG. 1.

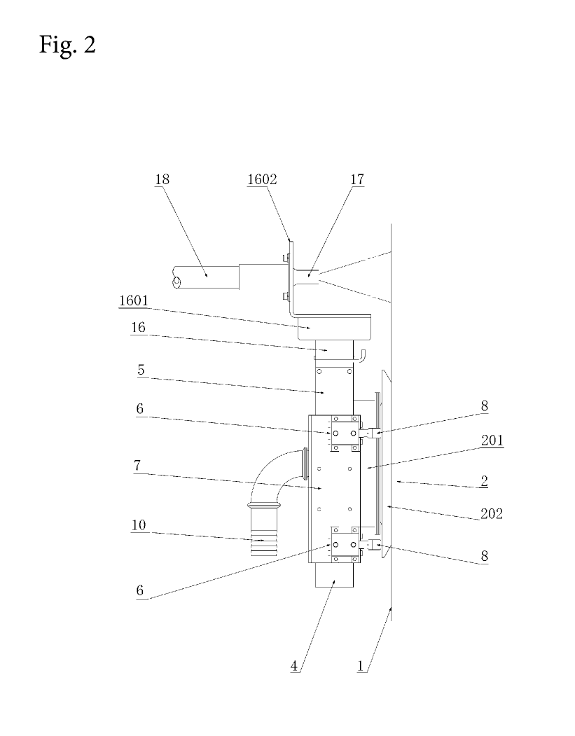

FIG. 3 is a rear view of the device shown in FIG. 1 and seen from the direction of an object surface.

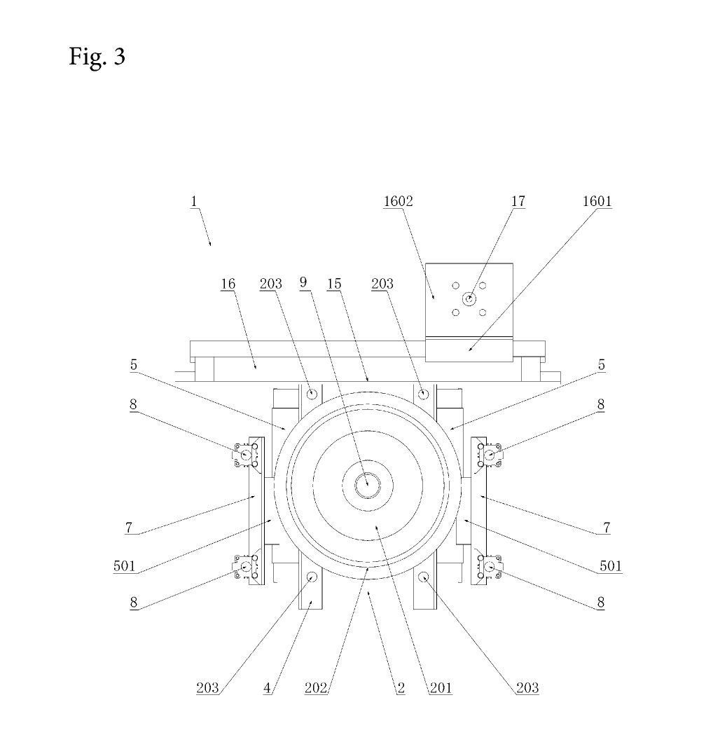

FIG. 4 is a bottom view of the device shown in FIG. 1.

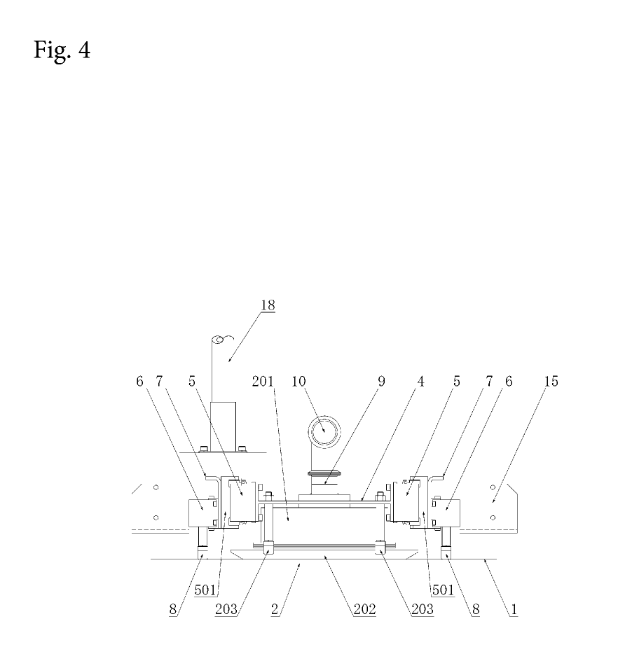

FIG. 5 is a cross-sectional view of the device shown in FIG. 1 taken along a line A-A.

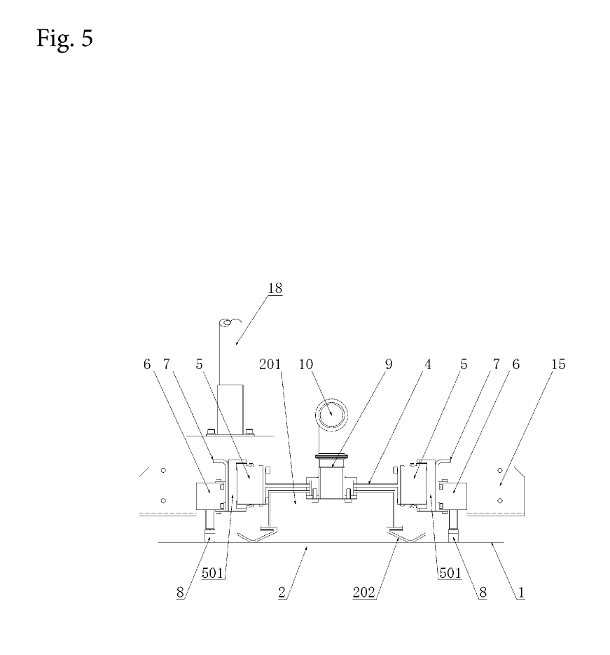

FIG. 6 is a bottom view and a partial cross-sectional view of the device shown in FIG. 1 taken along the line A-A showing the state in which double-acting leg members of a vertical reciprocation unit is separated from an object surface.

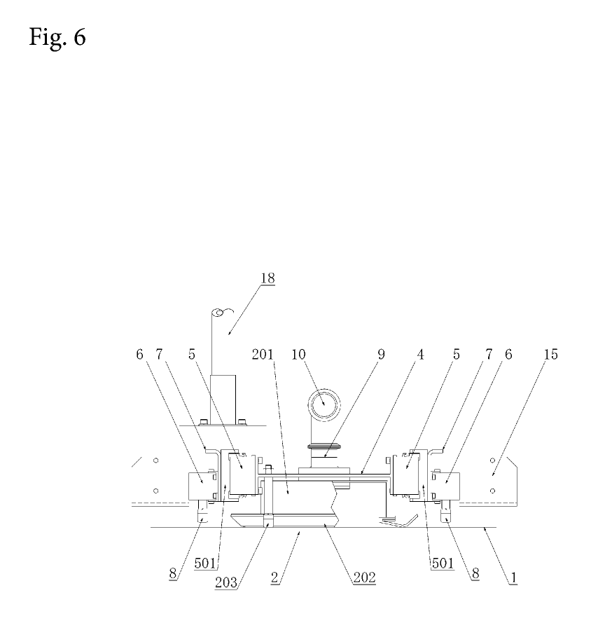

FIG. 7 is a rear view, a bottom view and a partial cross-sectional view of the device shown in FIG. 1 showing the action of the device in the first step in the drawing showing the steps in which a working device or an inspection device scans the object surface and the entire device travels along the object surface.

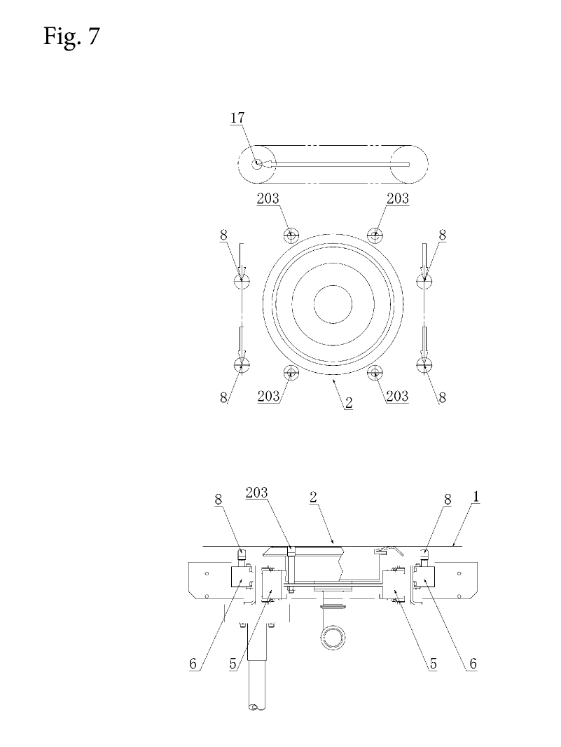

FIG. 8 is a rear view, a bottom view and a partial cross-sectional view showing action of the device in the second step.

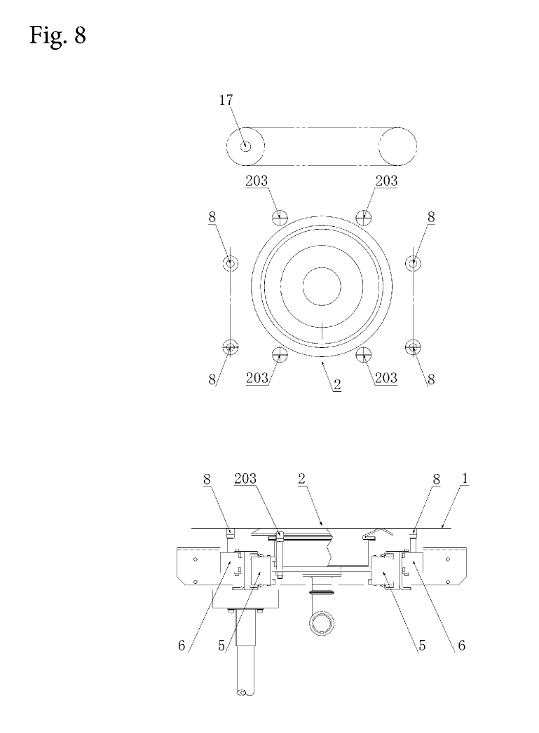

FIG. 9 is a rear view, a bottom view and a partial cross-sectional view showing action of the device in the third step.

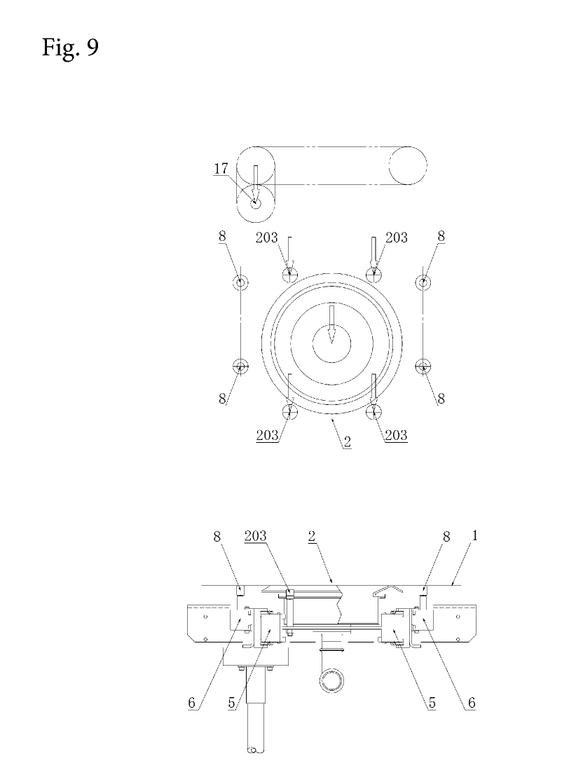

FIG. 10 is a rear view, a bottom view and a partial cross-sectional view showing action of the device in the fourth step.

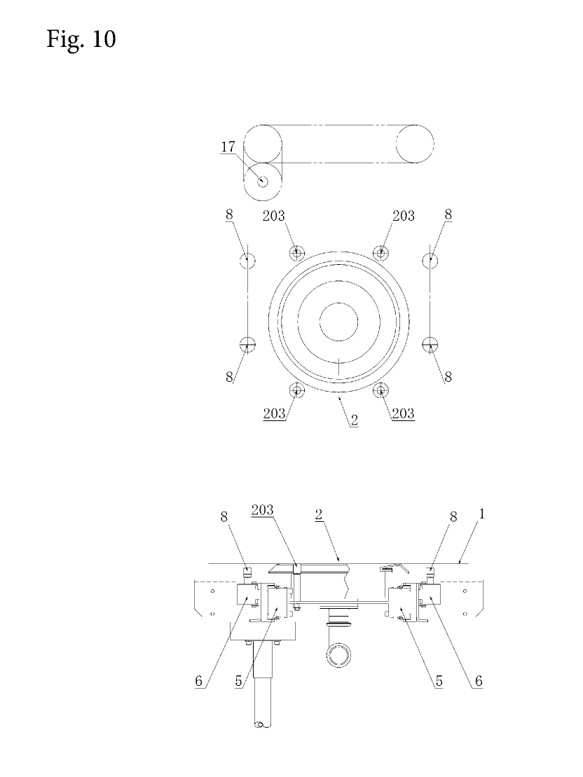

FIG. 11 is a rear view, a bottom view and a partial cross-sectional view of the device shown in FIG. 1 showing the state of the device immediately before the first step in the drawing showing the steps in which a working device or an inspection device scans the object surface and the entire device travels along the object surface, in.

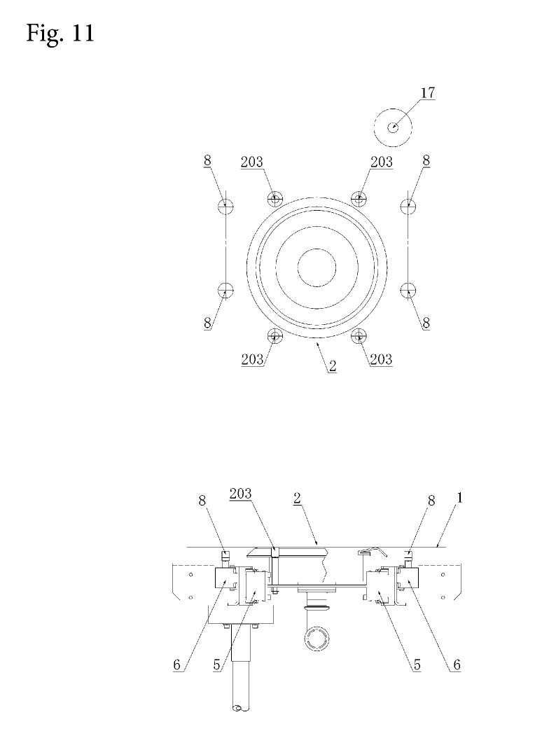

FIG. 12 is a bottom view of the device in which an adhering unit using the action of negative pressure in the device shown in FIGS. 1 to 11 is replaced with an adhering unit using the action of magnetic force.

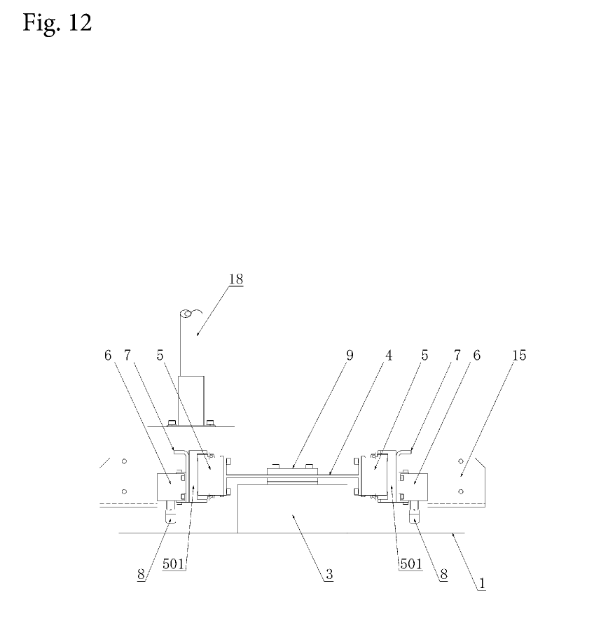

FIG. 13 is a cross-sectional view of the device taken along the line A-A in which the adhering unit using the action of negative pressure in the device shown in FIG. 1 is replaced with an adhering unit using the action of magnetic force.

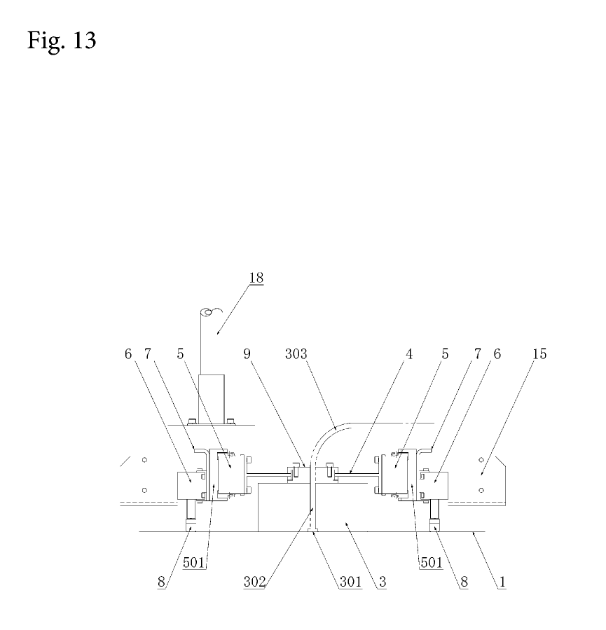

FIG. 14 is a front view showing the first preferred embodiment of the device configured according to the third invention related to this invention.

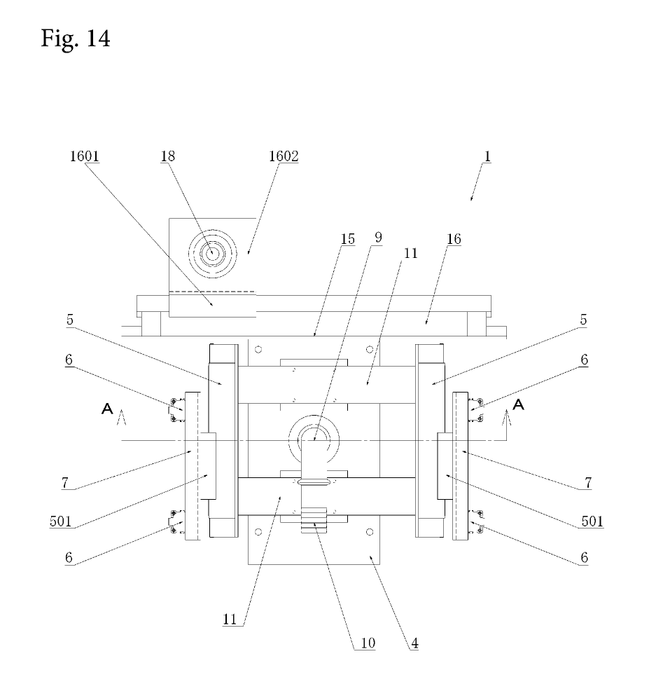

FIG. 15 is a right-side view of the device shown in FIG. 14.

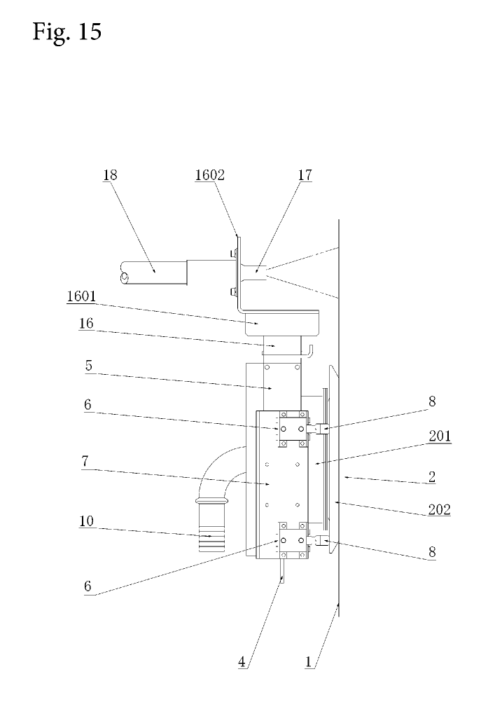

FIG. 16 is a rear view of the device shown in FIG. 14 and seen from the direction of the object surface.

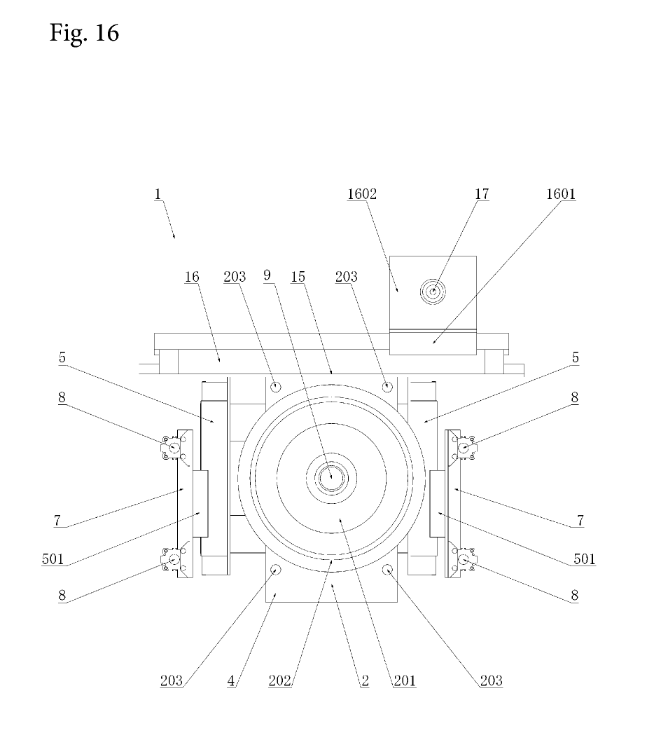

FIG. 17 is a bottom view of the device shown in FIG. 14.

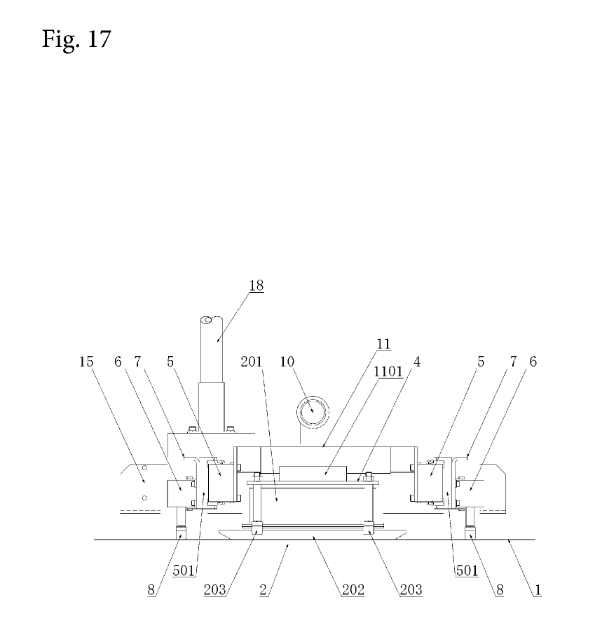

FIG. 18 is a cross-sectional view of the device shown in FIG. 14 taken along the line A-A.

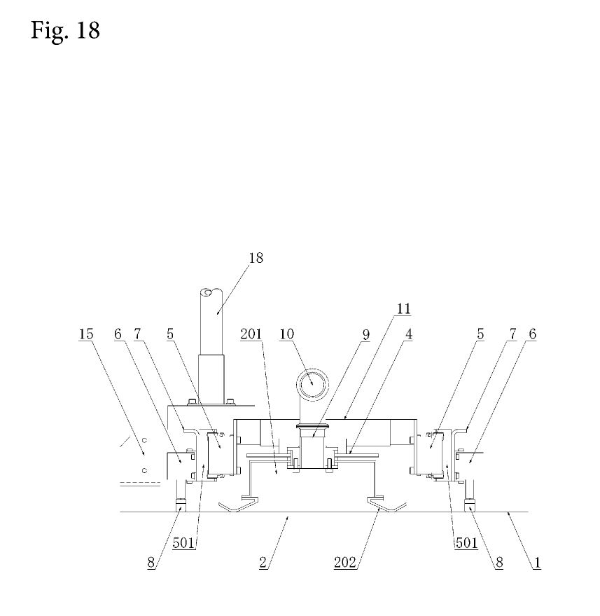

FIG. 19 is a bottom view and a partial cross-sectional view of the device shown in FIG. 14 taken along the line A-A showing the state in which double-acting leg members of a vertical reciprocation unit are separated from the object surface.

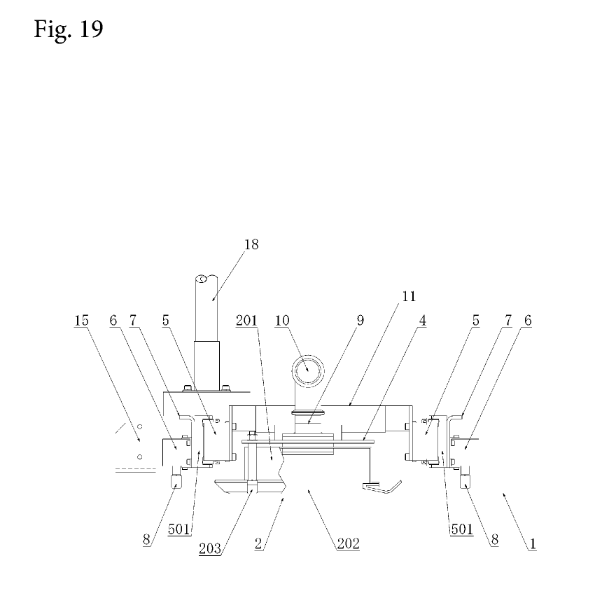

FIG. 20 is a rear view, a bottom view and a partial cross-sectional view showing the action of the device in the first step of the drawings showing the steps in which the working device or the inspection device scans the object surface and the entire device travels along the object surface in a Y-axis direction, in the device shown in FIG. 14.

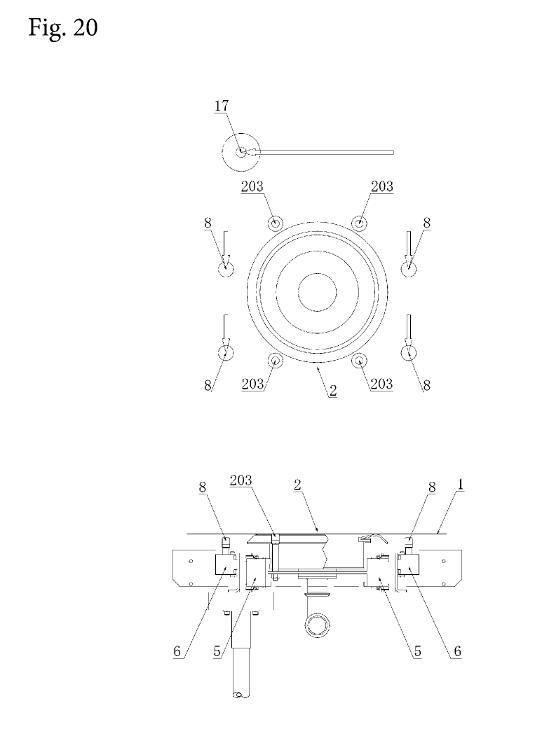

FIG. 21 is a rear view, a bottom view and a partial cross-sectional view showing the action of the device in the second step.

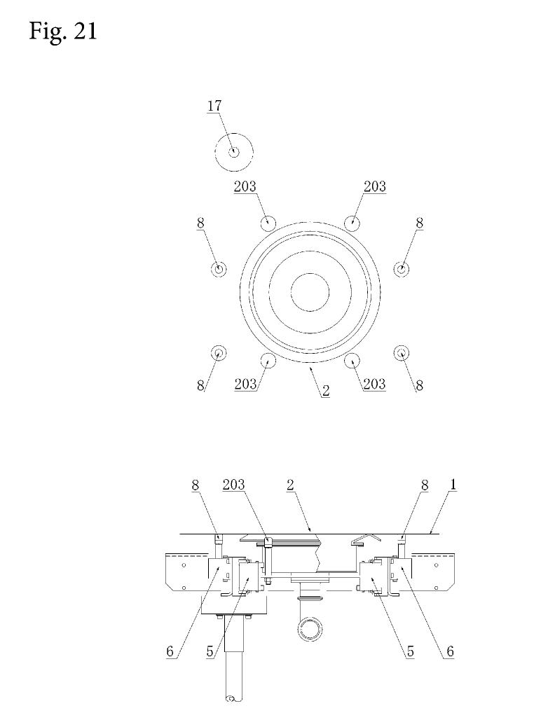

FIG. 22 is a rear view, a bottom view and a partial cross-sectional view showing the action of the device in the third step.

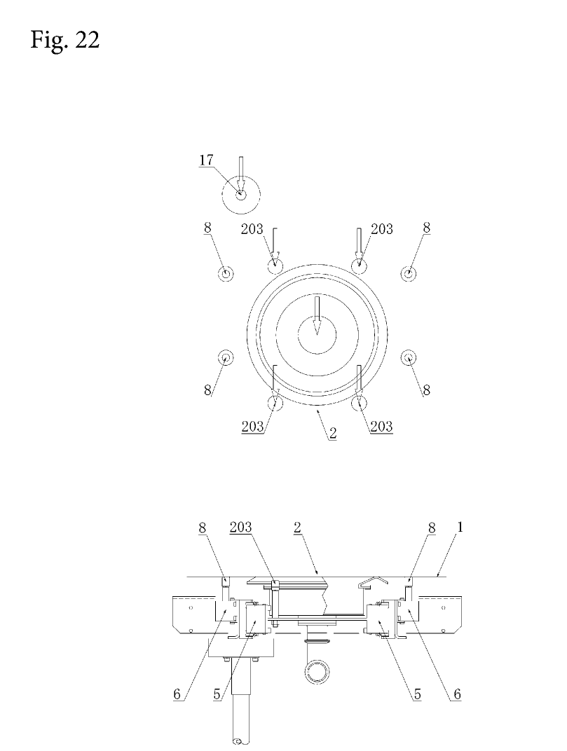

FIG. 23 is a rear view, a bottom view and a partial cross-sectional view showing the action of the device in the fourth step.

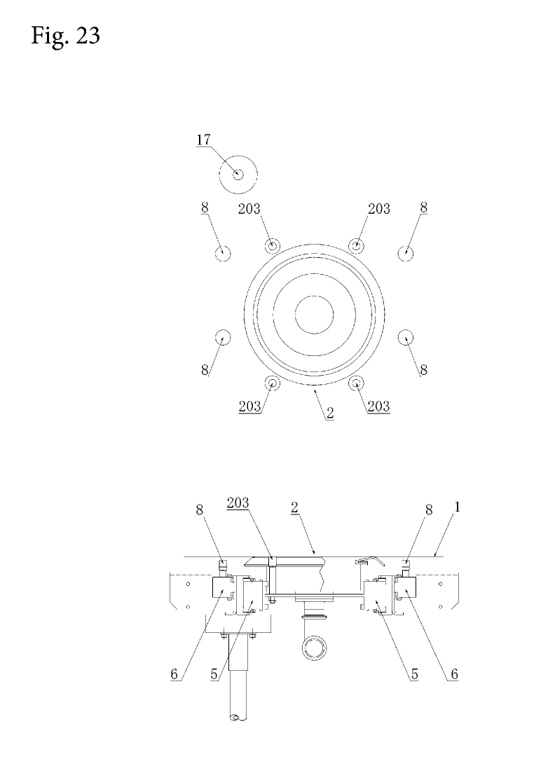

FIG. 24 is a rear view, a bottom view and a partial cross-sectional view showing the state of the device immediately before the first step in the drawing showing the steps in which the working device or the inspection device scans the object surface and the entire device travels along the object surface in the Y-axis direction, in the device shown in FIG. 14.

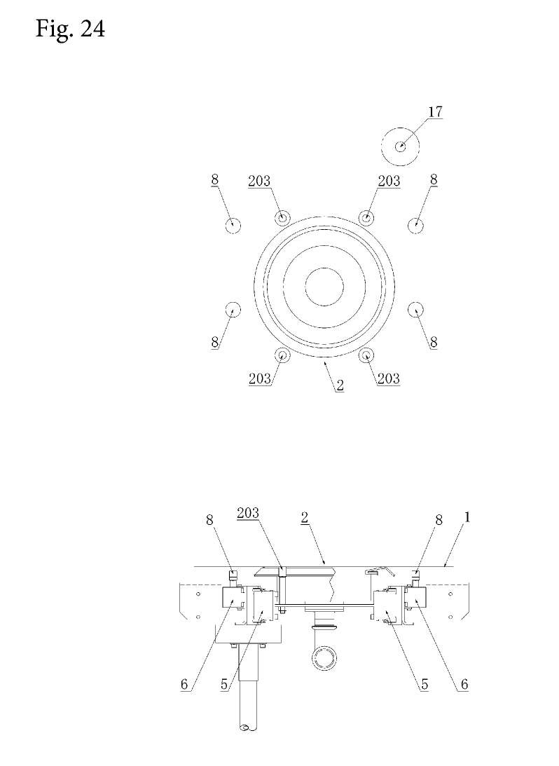

FIG. 25 is a bottom view of the device in which the adhering unit using the action of negative pressure in the device shown in FIGS. 14 to 24 is replaced with an adhering unit using the action of magnetic force.

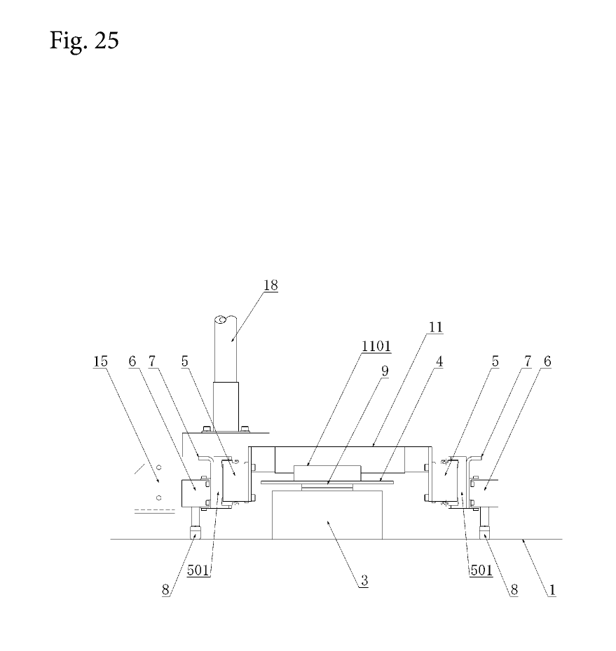

FIG. 26 is a cross-sectional view of the device taken along a line A-A in which the adhering unit using the action of negative pressure in the device shown in FIG. 14 is replaced with the adhering unit using the action of magnetic force.

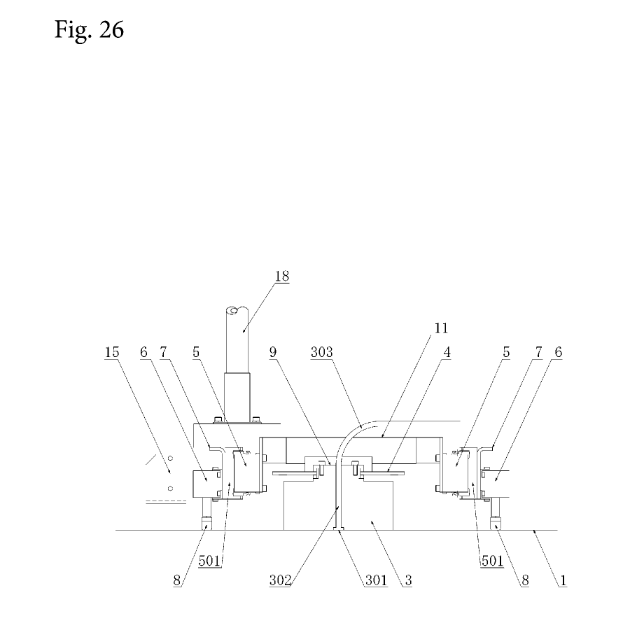

FIG. 27 is a rear view, a bottom view and a partial cross-sectional view showing the state of the device immediately before the first step, in the drawing showing the steps in which the entire device travels along the object surface in the X-axis direction, in the device shown in FIG. 14.

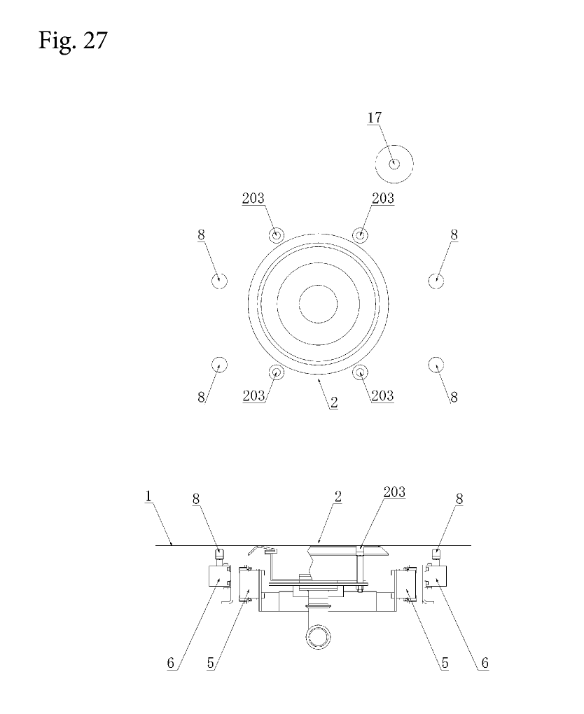

FIG. 28 is a rear view, a bottom view and a partial cross-sectional view showing the steps in which the entire device travels along he object surface in the Y-axis direction, in the device shown in FIG. 14.

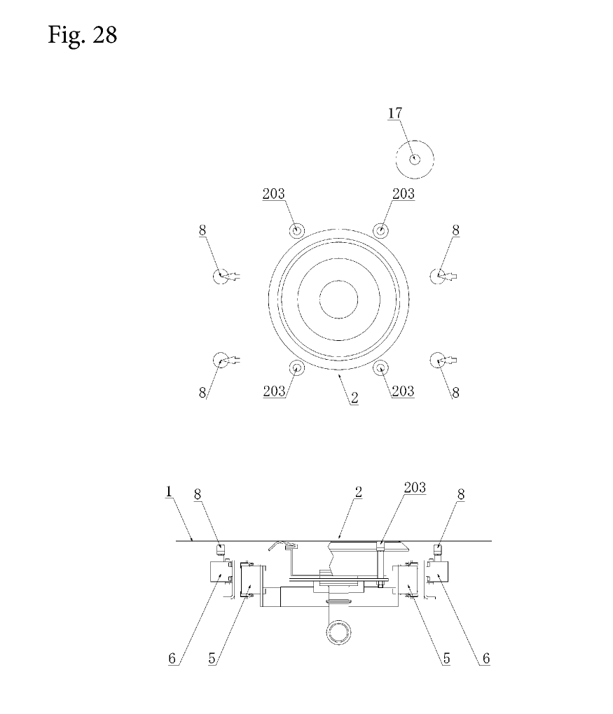

FIG. 29 is a rear view, a bottom view and a partial cross-sectional view showing the action of the device in the second step.

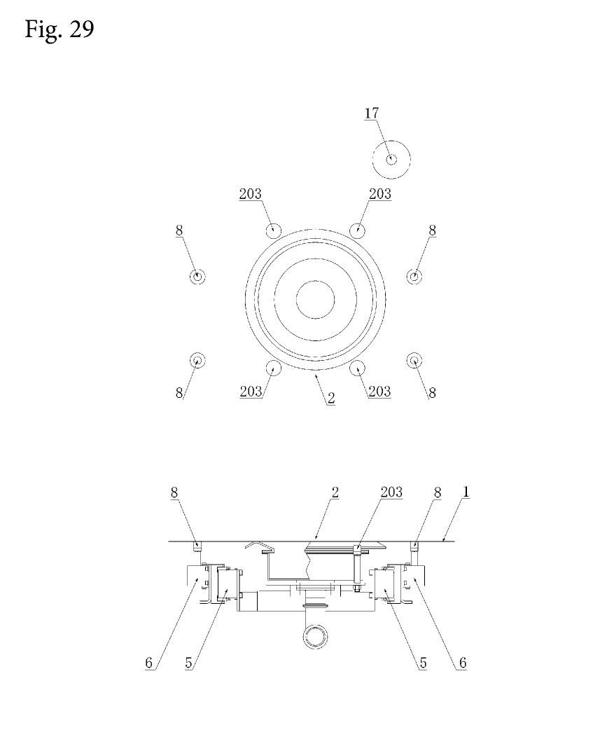

FIG. 30 is a rear view, a bottom view and a partial cross-sectional view showing the action of the device in the third step.

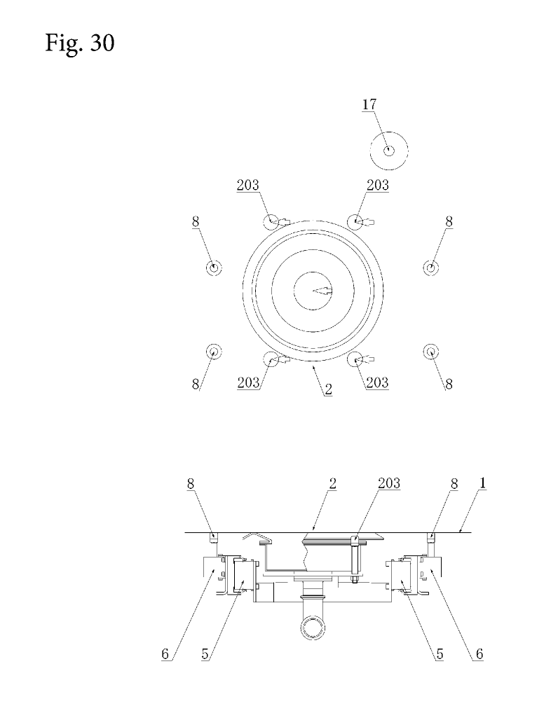

FIG. 31 is a rear view, a bottom view and a partial cross-sectional view showing the action of the device in the fourth step.

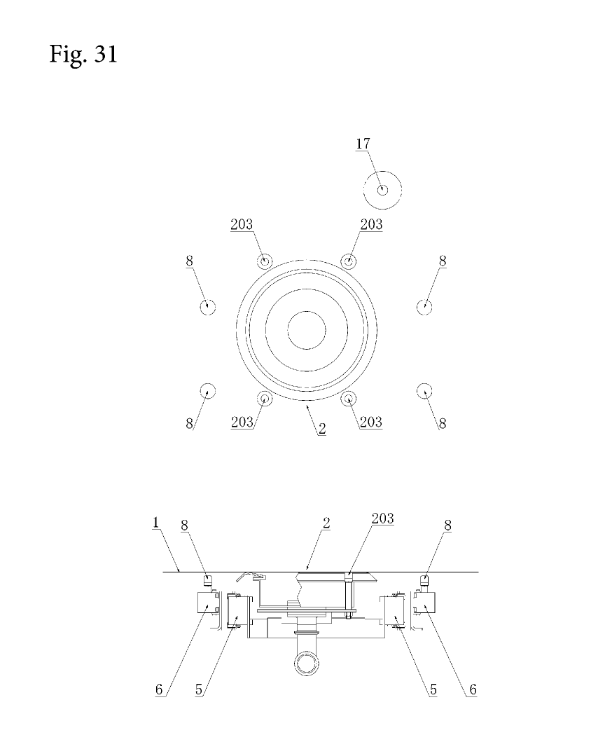

### DESCRIPTION OF THE REFERENCE NUMERALS

1: Object Surface
2: Negative Pressure Adhering Unit
201: Negative Pressure Adhering Unit Casing
202: Negative Pressure Adhering Unit Seal
203: Negative Pressure Adhering Unit Fixing Leg
3: Magnetically Adhering Unit
301: Fluid Blast Nozzle
302: Fluid Blast Pipe Member
303: Fluid Blast Hose
4: Main Frame
5: Horizontal Reciprocation Unit
501: Motion Member
6: Vertical Reciprocation Unit
7: Vertical Reciprocation Unit Frame
8: Double-Acting Leg Member
9: Rotary Coupling Means
10: Suction Hose Joint
15: Work Frame
16: Second Horizontal Reciprocation Unit
1601: Motion Member
1602: Nozzle Mounting Member
17: Polishing and Cleaning Material Blast Nozzle
18: Polishing and Cleaning Material Pressure-Feeding Blast Hose
5: Y-axis Horizontal Reciprocation Unit
11: X-axis Horizontal Reciprocation Unit
1101: Motion Member
16 Second X-axis Horizontal Reciprocation Unit

1. A device capable of adhering to an object surface and traveling therealong comprising:
an adhering unit adhering to the object surface by the action of negative pressure;
horizontal reciprocation units respectively arranged on right and left sides of the adhering unit with respect to the moving direction thereof, and capable of reciprocating in a front-back direction of the moving direction;
vertical reciprocation units mounted on each of the horizontal reciprocation units and capable of reciprocating in the direction intersecting with the object surface; and
double-acting leg members made of a material having a large friction coefficient like a polyurethane, respectively mounted on the vertical reciprocation units, and capable of reciprocating in the direction intersecting with the object surface;
in which, in order to enable the device adhering to the object surface to travel along the object surface;
as a first step, the double-acting leg members are strongly pressed against the object surface by the action of the vertical reciprocation units;
as a second step, the adhering unit adhering to the object surface is moved in the traveling direction of the device by driving the horizontal reciprocation units while maintaining the state that the double-acting leg members are strongly pressed against the object surface;
as a third step, the double-acting leg members are separated from the object surface by the action of the vertical reciprocation units;
as a fourth step, the double-acting leg members are moved in the traveling direction of the device and are returned to the state immediately before the first step by driving the horizontal reciprocation units while maintaining the state that the double-acting leg members are separated from the object surface; and
the operations of the first to fourth steps are repeated thereafter, by which the device adhering to the object surface travels intermittently therealong.

2. A device capable of adhering to an object surface and traveling therealong comprising:
an adhering unit adhering to the object surface by the action of negative pressure;
horizontal reciprocation units respectively arranged on right and left sides of the adhering unit with respect to the moving direction thereof, and capable of reciprocating in a front-back direction of the moving direction;
vertical reciprocation units mounted on each of the horizontal reciprocation units and capable of reciprocating in the direction intersecting with the object surface;
double-acting leg members made of a material having a large friction coefficient like a polyurethane, respectively mounted on the vertical reciprocation units, and capable of reciprocating in the direction intersecting with the object surface;
a working device working on the object surface to jet a surface treating material, etc., or an inspection device obtaining information from the object surface to inspect the object surface, etc.; and
a second horizontal reciprocation unit allowing the working device or the inspection device to reciprocate along the object surface in the direction intersecting with the moving direction of the adhering unit;
in which, in order to enable the working device or the inspection device to perform scanning along the object surface and to enable the device adhering to the object surface to travel along the object surface;
as a first step, the working device or the inspection device performs outward or homeward scanning by the action of the second horizontal reciprocation unit, and at the same time, the double-acting leg members are moved in the traveling direction of the device by driving the horizontal reciprocation units while maintaining the state that the double-acting leg members are separated from the object surface;
as a second step, the double-acting leg members are strongly pressed against the object surface by the action of the vertical reciprocation units;
as a third step, the adhering unit, and the working device or the inspection device are moved in the traveling direction of the device by driving the horizontal reciprocation units while maintaining the state that the double-acting leg members are strongly pressed against the object surface;
as a fourth step, the double-acting leg members are separated from the object surface by the action of the vertical reciprocation units and are returned to the state immediately before the first step; and
the operations of the first to fourth steps are repeated thereafter, by which the device adhering to the object surface travels intermittently along the object surface while working on the object surface or obtaining information from the same.

3. The device capable of adhering to the object surface and traveling therealong described in claim 1 comprising:
a coupling means to couple the adhering unit with the two horizontal reciprocation units including a rotary coupling means having an axis of rotation perpendicular to the object surface so that the two horizontal reciprocation units can rotate around the coupling means and along the object surface.

4. A device capable of adhering to an object surface and traveling therealong comprising:
an adhering unit adhering to the object surface by the action of magnetic force;
horizontal reciprocation units respectively arranged on right and left sides of the adhering unit with respect to the moving direction thereof, and capable of reciprocating in a front-back direction of the moving direction;
vertical reciprocation units respectively mounted on the horizontal reciprocation units and capable of reciprocating in the direction intersecting with the object surface; and
double-acting leg members made of a material having a large friction coefficient like a polyurethane, respectively mounted on the vertical reciprocation units, and capable of reciprocating in the direction intersecting with the object surface;
in which, in order to enable the device adhering to the object surface to travel along the object surface;
as a first step, the double-acting leg members are strongly pressed against the object surface by the action of the vertical reciprocation units;
as a second step, the adhering unit adhering to the object surface is moved in the traveling direction of the device by driving the horizontal reciprocation units while maintaining the state that the double-acting leg members are strongly pressed against the object surface;
as a third step, the double-acting leg members are separated from the object surface by the action of the vertical reciprocation units;
as a fourth step, the double-acting leg members are moved in the traveling direction of the device and are returned to the state immediately before the first step by driving the horizontal reciprocation units while maintaining the state that the double-acting leg members are separated from the object surface; and
the operations of the first to fourth steps are repeated thereafter, by which the device adhering to the object surface travels intermittently therealong.

5. (canceled)

6. The device capable of adhering to the object surface and traveling therealong described in claim 4 comprising:
a coupling means to couple the adhering unit with the two horizontal reciprocation units including a rotary coupling means having an axis of rotation perpendicular to the object surface so that the two horizontal reciprocation units can rotate around the coupling means and along the object surface.

7. The device capable of adhering to the object surface and traveling therealong described in claim 4 in which high-pressure fluid is injected into a gap between the adhering unit and the object surface when the adhering unit adhering to the object surface moves in the traveling direction of the device.

8.-21. (canceled)

22. The device capable of adhering to the object surface and traveling therealong described in claim 2 comprising:
a coupling means to couple the adhering unit with the two horizontal reciprocation units including a rotary coupling means having an axis of rotation perpendicular to the object surface so that the two horizontal reciprocation units can rotate around the coupling means and along the object surface.

23. The device capable of adhering to the object surface and traveling therealong described in claim 6 in which high-pressure fluid is injected into a gap between the adhering unit and the object surface when the adhering unit adhering to the object surface moves in the traveling direction of the device.
